(19) United States
(12) Patent Application Publication
(10) Pub. No.: US 2007/0110917 A1
(43) Pub. Date: May 17, 2007

(54) Bonding method, device formed by such method, surface activating unit and bonding apparatus comprising such unit

(75) Inventor: Masuaki Okada, Osaka (JP)

Correspondence Address: JAGTIANI + GUTTAG, 10363-A DEMOCRACY LANE, FAIRFAX, VA, 22030, US

(73) Assignee: Bondtech, Inc, Kyoto (JP)

(21) Appl. No.: 10/581,500

(22) PCT Filed: Dec. 2, 2004
(86) PCT No.: PCT/JP04/17934

§ 371 Date: Jun. 2, 2006

(30) Foreign Application Priority Data
Dec. 2, 2003 (JP) 2003-402526
Mar. 12, 2004 (JP) 2004-069865
Mar. 12, 2004 (JP) 2004-069866

(51) Int. Cl. B05D 3/00

(52) U.S. Cl. 427/532

(57) ABSTRACT

In a method of bonding objects to be bonded together in a solid phase at low temperature after subjecting bonding surfaces of the objects to be bonded to a hydrophilic treatment using a plasma, the objects to be bonded are conventionally handled in the atmospheric air for bonding, so that adhesion of organic substances in the atmospheric air leads to a reduction in bonding strength. Therefore, diffusion bonding needs to be performed at a temperature of as high as 1100° C. in the conventional art. According to the present invention, firm bond can be achieved at low temperature. In a method for bonding objects to be bonded together in a solid phase after subjecting bonding surfaces of the objects to be bonded to a hydrophilic treatment using a plasma, a chemical treatment step of subjecting both the objects to be bonded to the hydrophilic treatment using the plasma without exposure to the atmospheric air is performed after a physical treatment step of subjecting both the objects to be bonded to a physical treatment using an energy wave, such as an atom beam, an ion beam or a plasma, thereby bonding both the objects to be bonded together. Therefore, satisfactory bonding can be achieved without adhesion of organic substances or the like, thereby making it possible to achieve firm bond at a low temperature of 500° C. or less.

### TECHNICAL FIELD

The present invention relates to a technique of attaching a plurality of objects to be bonded (wafers, etc.) together by a hydrophilic treatment using a plasma.

### BACKGROUND ART

Conventionally, there is a known method for firmly bonding a wafer made of Si and a wafer made of glass or SiO₂ or wafers of SiO₂ together by subjecting surfaces of the wafers to a hydrophilic treatment using an oxygen plasma so that the surfaces are attached together by hydrogen bond, followed by annealing. In the conventional method, since the surfaces are cleaned by a wet process, the wafers are transported in the atmospheric air and are subjected to a hydrophilic treatment using an oxygen plasma in a vacuum chamber. The wafers are removed into the atmospheric air again, and are attached together, resulting in hydrogen bond. However, the strength is as weak as 3 MPa as illustrated in FIG. 9. Therefore, the wafers are heated to about 400° C., but in this case, the strength increases only to 5 MPa. Actually, diffusion bonding is performed at as high as 1100° C., thereby increasing the strength. In other words, the hydrogen bond obtained by an oxygen plasma only provides preliminary bonding.

Patent Document 1 discloses an exemplary method of etching metals using an Ar ion beam and bonding the surface-activated metals together at room temperature. In this method, however, organic substances or oxide film is removed from a surface to prepare an electrically-activated metal surface so that bonding is performed due to an atomic force, and therefore, firm bond cannot be achieved for Si (semiconductor), ceramic, and particularly glass and SiO₂, which are oxide materials.

When objects to be bonded are arranged facing each other and are subjected to a plasma treatment as disclosed in Patent Document 2, one of the objects to be bonded inevitably serves as a plasma electrode, so that reaction gas ions are accelerated and strike the plasma electrode. Therefore, this technique is suitable for physical etching which removes an organic substance layer, but not for a chemical treatment using OH groups or the like, because of being excessively strong thereto.

A method of using an atmospheric-pressure plasma is considered, however, the atmosphere does not allow acceleration of ions, so that the strike force of the ions is weak. Therefore, although surface activation can be achieved by a chemical treatment, an organic substance layer or the like which is initially present cannot be cleaned or removed by physical etching, so that bonding is performed, leaving the organic substance layer, resulting in a low strength.

Patent Document 1: JP S54-124853 A

Patent Document 2: JP 2003-318217 A

### DISCLOSURE OF THE INVENTION

Problem to be Solved by the Invention

In conventional methods, even when objects to be bonded are previously sufficiently cleaned, the objects are exposed to the atmospheric air, so that organic substances or other adhering substances readhere to surfaces thereof to at least some extent. A hydrophilic treatment using an oxygen plasma generates OH groups only by surface reforming of the organic substances on the surfaces, and the objects to be bonded are attached together by hydrogen bond of the OH groups on both the surfaces. In this case, low-temperature annealing before diffusion cannot increase the strength, because of the organic substance layer. Therefore, the strength is increased only by a method of performing diffusion at a temperature of as high as 1100° C., and mixing the organic substance layer together with a base material so that the organic substance layer is taken into crystal.

In the case of the method disclosed in Patent Document 1, since organic substances or oxide film is removed from a surface to prepare an electrically-activated surface of a metal or a semiconductor so that bonding is performed due to an atomic force, firm bond cannot be achieved for Si semiconductor, or particularly oxides such as glass and SiO₂, which are not metals.

Therefore, an object of the present invention is to provide a method and an apparatus for bonding objects to be bonded together in a solid phase at low temperature, in which both the objects to be bonded are subject to a physical treatment using an energy wave, such as an atom beam, an ion beam or a plasma (physical treatment step), and thereafter, the objects to be bonded is subjected to a chemical treatment using a plasma which has a weak ion strike force (chemical treatment step), thereby bonding both the objects to be bonded together.

In the method of surface-activating surfaces of objects to be bonded using OH groups or the like and tightly attaching and bonding both the surfaces together, although the surfaces are subjected to a hydrophilic treatment using an oxygen plasma and hydrogen bond is achieved by attaching wafers in the atmospheric air in conventional techniques, a typical plasma treatment technique is too strong to arrange OH groups neatly on a bonding surface, resulting in dropout or lack. Also, the surface of the object to be bonded is roughened, resulting in a gap which is a portion which does not allow bonding. Therefore, as illustrated in FIG. 9, the strength is as weak as 3 MPa. When heating is performed at about 100° C., the strength increases to as low as 4 MPa, and therefore, the strength is increased by heating at a temperature of as high as 400° C. or more. In conventional methods, high-temperature heating is inevitably required to achieve firm bond, leading to a problem with bonding of a device or the like which cannot endure distortion due to a difference in thermal expansion between different materials or high temperature. Here, 9 MPa is assumed to be a sufficient strength and 8 MPa is assumed to be a usable level, though a tensile strength illustrated in FIG. 9 varies depending on the measuring method.

In the case of the method of using an atmospheric-pressure plasma, the atmosphere does not allow acceleration of ions, so that the ion strike force is weak. Therefore, an adhering layer can be attached, but an organic substance layer or the like which is initially present cannot be cleaned or removed by etching, so that bonding is performed, leaving the organic substance layer, resulting in a low strength.

When objects to be bonded are arranged facing each other and are subjected to a plasma treatment as disclosed in Patent Document 2, one of the objects to be bonded inevitably serves as a plasma electrode, so that reaction gas ions are accelerated and strike the plasma electrode. Therefore, this technique is suitable for physical etching which removes an organic substance layer, but not for surface activation by a chemical treatment using OH groups or the like, because of being excessively strong thereto. As described above, there is not a method which satisfies both cleaning and adsorbing.

Means for Solving Problem

The surface activation treatment using an energy wave refers to a treatment which activates a bonding interface using an atom beam, an ion beam or a plasma so as to facilitate bonding. The principle of bonding due to surface activation can be considered as follows. In the case of a material, such as a metal, adhering substances, such as organic substances, oxide film or the like, are removed by etching from surfaces to generate active dangling bonds of metal atoms on the surface, whereby the other dangling bonds are bonded together. Also, if objects to be bonded are made of Si or an oxide including glass, SiO₂ or ceramics, the bonding surfaces are activated using OH groups by a hydrophilic treatment using an oxygen or nitrogen plasma, and the other OH groups are bonded together. Regarding the plasma, in addition to a low-pressure plasma, there is an atmospheric-pressure plasma which can be used under the atmospheric pressure and can be easily handled.

According to the present invention, bonding is performed after surface activation using an energy wave in accordance with the bonding principle, thereby performing bonding at lower temperature and increasing the bonding strength. The present invention is characterized by a surface activation step in which a treatment having a physical treatment using enhanced ion strike is continuously switched to a treatment which promotes a chemical treatment in which the ion strike force is reduced and the amount of radicals is increased, thereby efficiently promoting adhesion of OH groups to achieve a hydrophilic treatment.

The physical treatment refers to a phenomenon in which a surface layer is etched, and a phenomenon in which ion molecules strike the surface layer and replace surface molecules or adhere to a surface. The physical treatment is, for example, an act of etching an adhering layer with Ar ions of an Ar plasma, or replacement of the surface layer with oxygen ions or adhesion of oxygen ions to the surface a layer in the case of an oxygen plasma. The chemical treatment refers to a phenomenon in which the surface layer is treated by a chemical reaction due to active radicals, or active ions having a reduced ion strike force.

For example, if an oxygen plasma treatment is performed after an Ar plasma treatment, etching is performed with Ar having a large atomic weight, and adhesion of OH groups is performed by a chemical reaction due to active oxygen of an oxygen plasma. Also, even when the same oxygen plasma is used, impurities are removed by etching using an initial treatment having an enhanced ion strike force, and at the same time, oxygen is caused to replace and adhere to the surface layer by using striking ions, thereby producing a basis which enables adhesion of OH groups. In this state, OH groups are attached to some extent, however, the ion strike force is so strong that the OH group is stripped off from some portions. Next, the ion strike force is reduced and a chemical treatment using a number of ions or radicals having a weak activity is performed, thereby efficiently promoting adhesion of OH groups.

Based on the principle, both a bonding method and a surface activating unit according to the present invention for solving the above-described problems will be collectively described.

To solve the above-described problems, the present invention provides a bonding method for bonding objects to be bonded together in a solid phase at 500° C. or less after subjecting bonding surfaces of the objects to be bonded to a hydrophilic treatment using a plasma, wherein a chemical treatment step of subjecting both the objects to be bonded to a chemical treatment using a plasma having a weak ion strike force is performed after a physical treatment step of subjecting both the objects to be bonded to a physical treatment using an energy wave having a strong ion strike force, the energy wave being an atom beam, an ion beam or a plasma, thereby bonding both the objects to be bonded together (claim 1).

The present invention also provides a surface activating unit for bonding objects to be bonded together in a solid phase at 500° C. or less after subjecting bonding surfaces of the objects to be bonded to a hydrophilic treatment using a plasma, wherein the unit comprises an energy wave emitting means and/or a plasma emitting means; and a chemical treatment step of subjecting both the objects to be bonded to a chemical treatment using a plasma having a weak ion strike force is performed after a physical treatment step of subjecting both the objects to be bonded to a physical treatment using an energy wave having a strong ion strike force, the energy wave being an atom beam, an ion beam or a plasma (claim 20).

A surface is etched with an energy wave to remove adhering substances and expose a newly generated surface of a base material. In this situation, the surface is subjected to a chemical treatment using a plasma of a reaction gas, such as oxygen, nitrogen or the like, thereby making it possible to perform a hydrophilic treatment without an organic substance layer. Therefore, since there is no stripping off of an organic substance layer having a weak strength after bonding due to a hydrogen bonding force or a weak strength after annealing, a sufficient bonding strength can be obtained only by annealing at low temperature for releasing H₂O after achieving hydrogen bond and without diffusion.

Note that an amount etched using the energy wave is preferably 1 nm or more. Even when the object to be bonded is exposed to the atmospheric air after wet cleaning, adhering substances adhere to the surface of the object to be bonded to 1 nm or more within several seconds. Therefore, it is effective to etch by at least 1 nm or more.

The present invention also provides the bonding method according to claim 1, wherein an energy wave emitting means of the physical treatment step is a plasma (claim 2).

The present invention provides the surface activating unit according to claim 20, wherein an energy wave emitting means of the physical treatment step is a plasma (claim 21).

If the energy wave emitting means is a plasma, it is a simple and low-cost means as compared to other energy waves, and the same means as that which is used in the chemical treatment step can be used, whereby it is easy and only one chamber may be required.

The present invention also provides the bonding method according to claim 1 or 2, wherein a reaction gas of the chemical treatment step is oxygen or nitrogen (claim 3).

The present invention also provides the surface activating unit according to claim 20 or 21, wherein a reaction gas of the chemical treatment step is oxygen or nitrogen (claim 22).

As the plasma used in the chemical treatment step, oxygen is preferably used since adhesion of OH groups is facilitated. Also, when nitrogen is used, adhesion of OH groups can be similarly achieved.

The present invention also provides the bonding method according to any of claims 1 to 3, wherein, after the physical treatment step, evacuation is performed before the chemical treatment step (claim 4).

The present invention also provides the surface activating unit according to any of claims 20 to 22, wherein, after the physical treatment step, evacuation is performed before the chemical treatment step (claim 23).

When a surface is etched using an Ar plasma, Ar atoms may adhere to or may be implanted into the surface. Also, when etching is performed using a CF₄ plasma, F (fluorine) may adhere to a surface layer. After etching, evacuation is further performed from a plasma generating region, thereby more effectively releasing and removing Ar or F (fluorine). Also, at the same time, it is more effective to heat to about 100° C. After evacuation, a reaction gas may be loaded so that the degree of vacuum may be increased to a level which allows generation of a plasma.

The present invention also provides the bonding method according to claims 1 to 4, wherein, during or after the chemical treatment, a gas containing H₂O or H or OH groups is introduced and mixed before bonding (claim 5).

The present invention also provides the surface activating unit according to claims 20 to 23, comprising a water gas generating means, wherein, during or after the chemical treatment, a gas containing H₂O or H and OH groups is introduced and mixed before bonding (claim 24).

A gas containing H₂O or H and OH groups is also called a water gas. Typically, when a treatment is performed using an oxygen plasma and transportation is performed in the atmospheric air, since the atmospheric air contains moisture, OH groups are naturally generated. However, when treatments are performed in a vacuum without exposure to the atmospheric air until bonding in order to avoid adhesion of impurities and organic substances, moisture may be insufficient so that a sufficient number of OH groups are not generated. Therefore, it is effective to supply a gas containing H₂O or H and OH groups during the oxygen plasma treatment or until bonding after the treatment. Although a water gas can be directly supplied, it is more effective to mix a water gas into oxygen, or activate a water gas by subjecting it as a reaction gas to a plasma treatment continuously after the oxygen plasma treatment.

The present invention also provides the bonding method according to any of claims 1 to 5, wherein a reaction gas of the physical treatment step is different from a gas of the chemical treatment step, and is Ar or CF₄ (claim 6).

The present invention also provides the surface activating unit according to any of claims 20 to 24, wherein a reaction gas of the physical treatment step is different from a gas of the chemical treatment step, and is Ar or CF₄ (claim 25).

If inert Ar is used as the plasma employed in the physical treatment step, any material is not affected, and since the atomic weight of Ar is large, the ion strike force is preferably great. Also, if oxygen or nitrogen is used in the chemical treatment step, since the atomic weight of Ar in the physical treatment step is larger, the ion strike force is stronger, and in the chemical treatment step, the ion strike force is reduced, thereby promoting the chemical treatment. When at least one of the objects to be bonded is made of Si, SiO₂, glass or ceramic, the material can be efficiently etched by using CF₄ as the plasma reaction gas, which is suitable for the physical treatment step.

The present invention also provides the bonding method according to any of claims 1 to 6, wherein the physical treatment step and the chemical treatment step are performed without exposure to the atmospheric air (claim 7).

The present invention also provides the surface activating unit according to any of claims 20 to 25, wherein the physical treatment step and the chemical treatment step are performed without exposure to the atmospheric air (claim 26).

A surface is etched with an energy wave to remove adhering substances and expose a newly generated surface of a base material. In this state, by performing a hydrophilic treatment using a plasma without exposure to the atmospheric air, thereby making it possible to perform a hydrophilic treatment without readhesion due to contact with the atmospheric air, thereby avoiding an organic substance layer to a further extent.

As illustrated in FIG. 9, in the case of a conventional method in which bonding is performed using an oxygen plasma treatment after transportation in the atmospheric air, the bonding strength is 3 MPa at room temperature, 5 MPa at 400° C., and 10 MPa at 1100° C. This is because adhesion of organic substances occurs during transportation in the atmospheric air, so that a bonding surface containing an organic substance layer is included and therefore the bonding strength is not increased, and therefore, the strength is increased only by diffusion. However, if a plasma treatment is performed by Ar etching in a vacuum, followed by a hydrophilic treatment using an oxygen plasma without exposure to the atmospheric air, the bonding strength is 6 MPa even at room temperature, 8 MPa at 200° C., and 9 MPa at 400° C. Thus, a sufficient bonding strength substantially equal to that which is obtained by diffusion bonding at 1100° C., was able to be obtained. Even at 200° C., a sufficient bonding strength is obtained, but 400° C. is more preferable. It was found that, when the bonding strength was measured in a high vacuum after a treatment using an Ar ion beam, the bonding strength was 5 MPa at room temperature and the bonding strength was not increased even by heating to 400° C. more than in the conventional art.

Note that a bonding method and a surface activating unit may be provided in which the energy wave is a plasma, and both the objects to be bonded are provided facing each other in the same vacuum chamber, and the physical treatment step using a plasma is performed, continuously following by the chemical treatment step using a plasma in the same chamber.

Separate chambers for the dry cleaning using an energy wave and for the oxygen plasma treatment, can be handled. However, when Ar plasma etching is performed using an Ar gas, continuously followed by performing a hydrophilic treatment using an oxygen gas replacing the Ar gas in the same chamber, the possibility of readhesion is eliminated. Also, only one chamber is required, resulting in a compact size and a reduction in cost. Also, if the energy wave is a plasma, the same apparatus as that for the, hydrophilic treatment using an oxygen plasma can be used as it is, resulting in high efficiency. Also, a high vacuum is not required as compared to other energy waves.

Also, a bonding method and a surface activating unit in which the plasma is generated using an alternating power supply may be provided. By using the alternating power supply, positive ions and negative electrons alternately strike the surface of the object to be bonded, so that neutralization occurs, resulting in less damage (charge-up damage, etc.) as compared to other energy waves. Therefore, this technique is suitable for semiconductors and devices.

The present invention also provides the bonding method according to any of claims 2 to 5, wherein a plasma treatment means for changing the ion strike force is provided, and the ion strike force is reduced in a second half of a plasma treatment so that the chemical treatment is promoted (claim 8).

The present invention also provides the surface activating unit according to any of claims 21 to 24, comprising a plasma treatment means for changing the ion strike force, wherein the ion strike force is reduced in a second half of a plasma treatment so that the chemical treatment is promoted (claim 27).

Regarding the hydrophilic treatment using the plasma treatment, by performing a plasma treatment using a reduced ion strike force in the second half of the plasma treatment, there are a number of ions or radicals which are not accelerated, whereby a chemical reaction is promoted and the chemical treatment is uniformly performed on the bonding surface, thereby making it possible to perform a surface activation treatment. In a typical plasma treatment, impurities are removed by a physical treatment effect, and attachment and arrangement of OH groups and replacement with nitrogen or the like are performed on a surface using a chemical treatment effect. In a typical plasma treatment, however, adhering substances caused by the chemical treatment effect of the surface are unfortunately removed due to a strong ion strike force, thereby making it difficult to uniformly perform the chemical treatment on the surface.

Therefore, in the second half of the plasma treatment, the ion strike force is reduced to perform a plasma treatment. In this case, there are a number of ions or radicals which are not accelerated, whereby a chemical reaction is promoted and the chemical treatment is uniformly performed on the bonding surface, thereby making it possible to perform a surface activation treatment. Therefore, the bonding strength can be increased at low temperature. Regarding the low temperature, bonding can be preferably achieved at a temperature of 400° C. or less, as compared to 400° C. or more required in the conventional art.

Note that a bonding method and a surface activating unit in which the bonding temperature is 200° C. or less may be provided. As illustrated in FIG. 9, more preferably, bonding can be achieved at 200° C. The second half of the plasma treatment is not limited to half of a time and has a meaning which does not relate to time. There may be an interval between the first and second halves of the plasma treatment, but it is preferable in terms of the chemical treatment that they be continuous. Particularly, before claims 8 and 27, the physical treatment refers to etching for removing impurities as a pretreatment for adhesion of OH groups, but in claims 8 and 27, in the step of adhesion of OH groups, to changing the ion strike force to cause adhesion of oxygen using the physical treatment, and accelerating adhesion of OH groups using the chemical treatment, aiming efficient adhesion of OH groups.

The present invention also provides the bonding method according to claim 8, wherein the plasma treatment means for changing the ion strike force is a low-pressure plasma; the plasma treatment means comprises a plasma electrode including an object-to-be-bonded holding electrode and a counter surface electrode which are provided at two positions and can be switched; and a power supply is applied to the object-to-be-bonded holding electrode to perform a plasma treatment, and thereafter, a power supply is applied to the counter surface electrode to reduce the ion strike force, thereby performing a plasma treatment for promoting the chemical treatment (claim 9).

The present invention also provides the surface activating unit according to claim 27, wherein the plasma treatment means for changing the ion strike force is a low-pressure plasma; the plasma treatment means comprises a plasma electrode including an object-to-be-bonded holding electrode and a counter surface electrode which are provided at two positions and can be switched; and a power supply is applied to the object-to-be-bonded holding electrode to perform a plasma treatment, and thereafter, a power supply is applied to the counter surface electrode to reduce the ion strike force, thereby performing a plasma treatment for promoting the chemical treatment (claim 28).

On the plasma electrode side, since electric field is generated, ions are accelerated to strike, thereby increasing an ion strike force. On the counter surface facing the electrode, ions are not accelerated to strike, so that the ion strike force is low, but there are a number of ions or radicals which are not accelerated, so that a chemical reaction is promoted. A plasma electrode is provided which includes an object-to-be-bonded holding electrode and a counter surface electrode which are provided at two positions and can be switched. A power supply is applied to the object-to-be-bonded holding electrode to perform a plasma treatment, and thereafter, a power supply is applied to the counter surface electrode to reduce the ion strike force, thereby performing a plasma treatment. Thereby, impurities are removed and there are a number of ions or radicals which are not accelerated, due to a reduced ion strike force, a chemical reaction is promoted, thereby making it possible to uniformly perform surface activation of a bonding surface. Therefore, it is possible to increase a bonding strength at low temperature.

A difference in temperature and bonding strength between when a plasma power supply is applied only to an object-to-be-bonded holding electrode as in the conventional art, and when a process of switching between an object-to-be-bonded holding electrode and a counter surface electrode, is illustrated in FIG. 14. Although 400° C. is required to obtain a sufficient strength in the conventional art, this technique was able to achieve a sufficient bonding strength at room temperature to 200° C. or less, i.e., lower than or equal to 400° C. The counter electrode may be opposed like a parallel plate type, or may be provided at a surrounding position other than the electrode and, in this case, a similar effect is obtained. In order to avoid readhesion of an electrode material due to sputtering etching, a side surface is more preferable than the counter surface. As used herein, the counter surface electrode may be provided at these surrounding positions.

The present invention also provides the bonding method according to claim 8, wherein the plasma treatment means for changing the ion strike force is a low-pressure plasma; the plasma treatment means comprises an RF plasma power supply capable of adjusting Vdc; and a Vdc value is changed in the second half of the plasma treatment to reduce the ion strike force so that a plasma treatment for promoting the chemical treatment is performed (claim 10).

The present invention also provides the surface activating unit according to claim 27, wherein the plasma treatment means for changing the ion strike force is a low-pressure plasma; the plasma treatment means comprises an RF plasma power supply capable of adjusting Vdc; and a Vdc value is changed in the second half of the plasma treatment to reduce the ion strike force so that a plasma treatment for promoting the chemical treatment is performed (claim 29).

On the plasma electrode side, electric field is generated, and a speed of striking ions varies depending on the Vdc value. As illustrated in FIG. 10, the larger the negative value of Vdc, the more +oxygen ions are accelerated, so that the ion strike force is increased. As the negative value of Vdc approaches zero, the speed becomes slower, so that the ion strike force is reduced. In this case, there are a number of ions or radicals which are not accelerated, so that a chemical reaction is promoted. When a plasma treatment is performed by setting the Vdc value to be a large negative value, and thereafter, the Vdc value is caused to approach zero to perform an adsorption step, so that a plasma treatment using a reduced ion strike force is performed in the second half of the plasma treatment, impurities are removed and there are a number of ions or radicals which are not accelerated, due to the reduced ion strike force, thereby making it possible to promote a chemical reaction to uniformly perform surface activation with respect to a bonding surface. Therefore, the bonding strength can be increased at low temperature. The result of bonding similar to that of FIG. 14 was obtained.

The present invention also provides the bonding method according to claim 8, wherein the plasma treatment means for changing the ion strike force is a low-pressure plasma; the plasma treatment means comprises a pulsed-wave plasma power supply capable of adjusting a pulse width; and the pulse width is changed in the second half of the plasma treatment to reduce the ion strike force so that a plasma treatment for promoting the chemical treatment is performed (claim 11).

The present invention also provides the surface activating unit according to claim 27, wherein the plasma treatment means for changing the ion strike force is a low-pressure plasma; the plasma treatment means comprises a pulsed-wave plasma power supply capable of adjusting a pulse width; and the pulse width is changed in the second half of the plasma treatment to reduce the ion strike force so that a plasma treatment for promoting the chemical treatment is performed (claim 30).

On the plasma electrode side, electric field is generated, and as illustrated in FIG. 11, by adjusting the pulse width, a time interval of − electric field in which + ions strike and a time interval of weak − electric field in which the strike is reduced can be adjusted. When the time of − electric field is increased, the strike of + ions is enhanced. When the time of − electric field is decreased, the strike of + ions is reduced.

For example, the longer the time of − electric field, the more the + oxygen ions are accelerated, so that the ion strike force is increased. The shorter the time of − electric field, the slower the speed, so that the ion strike force is decreased. In this case, there are a number of ions or radicals which are not accelerated, resulting in promotion of a chemical reaction. A plasma treatment is performed while the time of − electric field is increased by adjusting the pulse width, and thereafter, a plasma treatment is performed while the time of − electric field is decreased, so that, after a low-pressure plasma treatment in which the ion strike force is increased, a plasma treatment using a reduced ion strike force is performed, so that impurities are removed and there are a number of ions or radicals which are not accelerated, due to the reduced ion strike force, thereby making it possible to promote a chemical reaction to uniformly perform surface activation with respect to a bonding surface. Therefore, the bonding strength can be increased at low temperature. The result of bonding similar to that of FIG. 14 was obtained.

Note that a bonding method and a surface activating unit may be provided in which, after the treatment step, bonding surfaces of a plurality of objects to be bonded are tightly attached and bonded together in the atmospheric air. In this case, by reducing the ion strike force in the second half of the plasma treatment, a chemical reaction is promoted, thereby making it possible to uniformly performing a surface activation treatment with respect to the bonding surface. Since a chemical treatment, such as attachment of OH groups, replacement with nitrogen, or the like, is already performed with respect to the bonding surface, bonding can be achieved even in the atmospheric air.

Also, a bonding method and a surface activating unit may be provided in which, after the treatment step, bonding surfaces of a plurality of objects to be bonded are tightly attached and bonded together in a low pressure. Even when the pressure is once put back to the atmospheric pressure so that an adsorption layer is attached, by reducing the pressure in the vacuum chamber and tightly attaching and bonding both the objects to be bonded together, it is preferably possible to bond the objects to be bonded in a voidless manner without leaving the air at bonding interface.

The present invention also provides the bonding method according to 8, wherein the plasma treatment means for changing the ion strike force is means for switching between two low-pressure plasma emitting means; the first plasma emitting means applies a power supply to the object-to-be-bonded holding electrode to perform the plasma treatment; and in the second half of the plasma treatment, the first plasma emitting means is switched to the second plasma emitting means which traps plasma ions generated in another room and emits radicals, thereby reducing the ion strike force so that a plasma treatment for promoting the chemical treatment is performed (claim 12).

The present invention also provides the surface activating unit according to 27, wherein the plasma treatment means for changing the ion strike force is means for switching between two low-pressure plasma emitting means; the first plasma emitting means applies a power supply to the object-to-be-bonded holding electrode to perform the plasma treatment; and in the second half of the plasma treatment, the first plasma emitting means is switched to the second plasma emitting means which traps plasma ions generated in another room and emits radicals, thereby reducing the ion strike force so that a plasma treatment for promoting the chemical treatment is performed (claim 31).

As illustrated in FIG. 12, while a wafer (object to be bonded) is held by an object-to-be-bonded holding electrode (plasma power supply), an RF plasma power supply is initially applied to perform a physical treatment in which ions strike the object to be bonded. Following this, the object to be bonded is irradiated with a larger number of radicals generated by an upper surface wave plasma through an ion trapping plate in a down-flow manner. Ions are captured by the ion trapping plate, so that a larger number of radicals can be emitted, thereby promoting a chemical treatment. The result of bonding similar to that of FIG. 14 was obtained.

The present invention also provides the bonding method according to claim 8, wherein the plasma treatment means for changing the ion strike force is means for switching between a low-pressure plasma and an atmospheric-pressure plasma; after the surfaces of the objects to be bonded are treated with an ion strike force enhanced by the low-pressure plasma, the ion strike force is reduced with the atmospheric-pressure plasma so that a plasma treatment for promoting the chemical treatment is performed (claim 13).

The present invention also provides the surface activating unit according to claim 27, wherein the plasma treatment means for changing the ion strike force is means for switching between a low-pressure plasma and an atmospheric-pressure plasma; after the surfaces of the objects to be bonded are treated with an ion strike force enhanced by the low-pressure plasma, the ion strike force is reduced with the atmospheric-pressure plasma so that a plasma treatment for promoting the chemical treatment is performed (claim 32).

When the plasma treatment is divided into a low-pressure plasma and an atmospheric-pressure plasma, since ions are not accelerated in electric field in the case of the atmospheric-pressure plasma unlike in a vacuum, the ion strike force is weak, so that there are a number of ions or radicals which are not accelerated, thereby making it possible to promote a chemical reaction to uniformly perform surface activation with respect to a bonding surface. In the low-pressure plasma treatment impurities are removed using a physical treatment effect, and attachment and arrangement of OH groups and replacement with nitrogen or the like are performed on a surface using a chemical treatment effect. In the low-pressure plasma treatment, however, adhering substances caused by the chemical treatment effect of the surface are unfortunately removed due to a strong ion strike force, thereby making it difficult to uniformly perform the chemical treatment on the surface.

Therefore, an atmospheric-pressure plasma treatment is performed after the low-pressure plasma treatment. Thereby, since ions are not accelerated in electric field in the case of the atmospheric-pressure plasma unlike in a vacuum, the ion strike force is weak, so that there are a number of ions or radicals which are not accelerated, thereby making it possible to promote a chemical reaction to uniformly perform surface activation with respect to a bonding surface. Therefore, the bonding strength can be increased at low temperature. Regarding the low temperature, bonding can be preferably achieved at a temperature of 400° C. or less, as compared to 400° C. or more required in the conventional art. Note that a bonding method and a surface activating unit may be provided in which the bonding temperature is 200° C. or less. As illustrated in FIG. 14, more preferably, bonding can be achieved at 200° C. or less. Note that a bonding method and a bonding apparatus may be provided in, after the atmospheric-pressure plasma treatment, evacuation is performed again, and bonding is performed under a low pressure. If bonding is performed in a vacuum after a plasma treatment is performed under the atmospheric pressure, the bonding environment is satisfactory and bonding can be achieved without voids. Also, a bonding apparatus may be provided which comprises an atmospheric-pressure plasma nozzle which emits a plasma in two directions between the objects to be bonded opposed and held during the atmospheric-pressure plasma treatment. When the objects to be bonded are provided facing each other and are treated using the two-direction nozzle, a plasma treatment can be efficiently performed.

The present invention also provides the bonding method according to any of claims 8 to 13, wherein the reaction gas is a gas mixture containing oxygen and nitrogen (claim 14).

The present invention also provides the surface activating unit according to any of claims 27 to 32, wherein the reaction gas is a gas mixture containing oxygen and nitrogen (claim 33).

By using a gas containing nitrogen, a group containing O and N as well as an OH group are generated in a chemical treatment using a reduced ion strike force. Thereby, a chemical compound of Si, O and N is generated at interface during bonding, so that firm bond can be achieved even at room temperature. FIG. 14 illustrates comparison between when only an oxygen reaction gas was used and when a reaction gas containing oxygen and nitrogen was used. When only oxygen is used, firm bond is not achieved unless heating is performed to about 200° C. When oxygen and nitrogen are mixed, firm bond can be achieved even at room temperature to 100° C. or less.

Note that a bonding method and a surface activating unit may be provided in which a different gas or a different gas mixture is used as the plasma reaction gas in the second half of the plasma treatment. By using a different gas or a different gas mixture in the second half of the plasma treatment, the gas suitable for the chemical treatment can be preferably used. For example, an Ar gas is used in the first half of the plasma treatment and an oxygen gas is used in the second half, thereby making it possible to achieve an efficient plasma treatment. Alternatively, an oxygen gas can be used in the first half and nitrogen gas can be used in the second half. Instead of simply using different gases, a gas mixture of Ar and oxygen may be used, i.e., a larger amount of Ar may be mixed in the first half and a larger amount of oxygen may be mixed in the second half. When a gas mixture of oxygen and nitrogen is used, a larger amount of oxygen may be mixed in the first half and a larger amount of nitrogen may be mixed in the second half.

The present invention also provides the bonding method according to any of claims 8 to 13, wherein the plasma reaction gas is switched from a reaction gas containing oxygen to a reaction gas containing nitrogen during a plasma treatment using a reduced ion strike force (claim 15).

The present invention also provides the surface activating unit according to any of claims 26 to 32, wherein the plasma reaction gas is switched from a reaction gas containing oxygen to a reaction gas containing nitrogen during a plasma treatment using a reduced ion strike force (claim 34).

In the chemical treatment using the reduced ion strike force, by using a gas containing nitrogen, a group containing O and N as well as an OH group are generated. Also, since OH groups adhere to some extent in the first half of the plasma treatment, the OH group is replaced with N in the chemical treatment using the reduced ion strike force. Thereby, a chemical compound of Si, O and N is generated at interface during bonding, so that firm bond can be achieved even at room temperature. With this method, a satisfactory result similar to FIG. 14 was obtained.

Note that a bonding method and a surface activating unit may be provided in which bonding is performed in a solid phase at a heating temperature of 100° C. or less. Also, a bonding method and a surface activating unit may be provided in which bonding is performed in a solid phase at a heating temperature which is room temperature.

If only OH groups excluding water molecules are efficiently arranged, bonding can be achieved at 100° C. or less. If a chemical treatment is performed using a reaction gas containing nitrogen in the second half of the plasma treatment, bonding can be preferably achieved at room temperature. Also, a bonding method and a bonding apparatus may be provided in which an adsorption step of exposure to a gas containing water molecules or hydrogen under the atmospheric pressure is performed after the treatment step and before the bonding step. By exposure to a gas containing water molecules or hydrogen under the atmospheric pressure after the treatment step, water molecules or hydrogen are easily adsorbed to the bonding surface, so that OH groups are arranged, thereby easily achieving hydrogen bond, as compared to a low-pressure plasma containing less water molecules or hydrogen.

The present invention may also provide a bonding method and a surface activating unit in which two objects to be bonded are subjected to a plasma treatment and are bonded together in a single low-pressure chamber, and which comprises a head for holding the upper object to be bonded in the vacuum chamber under a low pressure, a stage for holding the lower object to be bonded, a pressing means for moving at least one of the stage and the head in a direction perpendicular to a bonding surface, a moving means for moving one of the stage and the head laterally, and a plasma treatment means for each of the objects to be bonded. Both the objects to be bonded are shifted to lateral positions so that the bonding surfaces do not overlap and faces the respective plasma treatment means. Both the bonding surfaces are subjected to a plasma treatment, and thereafter, the objects to be bonded are slid to bonding positions. At least one of the objects to be bonded is moved in a direction perpendicular to the bonding surfaces so that the bonding surfaces are bonded together.

If a plasma treatment is performed at a position where each object to be bonded is slid, a counter electrode can be provided on the counter surface of the object-to-be-bonded holding electrode. A plasma electrode is provided which includes an object-to-be-bonded holding electrode and a counter surface electrode which are provided at two positions and can be switched. A power supply is applied to the object-to-be-bonded holding electrode to perform a plasma treatment, and thereafter, a power supply is applied to the counter surface electrode to reduce the ion strike force in the second half of the plasma treatment. Thereby, a chemical reaction is promoted, thereby making it possible to uniformly perform surface activation of a bonding surface. Thereafter, the objects to be bonded are slid to overlap each other, and are tightly attached, thereby making it possible to bond the objects to be bonded together. With this technique, two objects to be bonded can be efficiently subjected to a plasma treatment in a single chamber and are bonded together. Also, after the plasma treatment step, the objects to be bonded can be easily exposed to the atmosphere, followed by adsorption, before bonding. Also, in the apparatus configuration of FIG. 1, an alignment step of performing alignment correction with respect to positions of both the objects to be bonded can be inserted before the bonding step, thereby making it possible to perform high-accuracy positioning before bonding.

The present invention also provides the bonding method according to any of claims 1 to 15, wherein, during the bonding, a voltage is applied between both the objects to be bonded so that the objects to be bonded are bonded together in a solid phase while being heated (claim 16).

The present invention also provides the surface activating unit according to any of claims 20 to 34, wherein, during the bonding, a voltage is applied between both the objects to be bonded so that the objects to be bonded are bonded together in a solid phase while being heated (claim 35).

When a voltage of 500 to 1000 V is applied between both the objects to be bonded, water molecules are efficiently discharged, so that firm bond can be achieved at low temperature as compared to when only heating is performed. Also, when at least one of the objects to be bonded is made of Si, SiO₂, glass or ceramic which contains a material which decomposes into ions due to a voltage, water molecules are more efficiently discharged with the help of an electrostatic force.

The present invention also provides the bonding method according to any of claims 1 to 16, wherein at least one of the objects to be bonded is made of Si, SiO₂, glass or ceramic (claim 17).

The present invention also provides the surface activating unit according to any of claims 20 to 35, wherein at least one of the objects to be bonded is made of Si, SiO₂, glass or ceramic (claim 36).

When an oxygen or nitrogen plasma is used to reduce the ion strike force in the second half to promote a chemical reaction, OH groups can be easily attached to and arranged on a bonding surface of Si, SiO₂, glass, ceramic, oxide or the like. If OH groups can be adsorbed, both the bonding surfaces are bonded together due to hydrogen bond by tightly attaching them together. As described as a conventional technique, the surface activation method using Ar etching is the only technique capable of achieving bonding at low temperature. However, since organic substances or oxide film is removed from a surface to create an electronically activated metal surface and bonding is achieved due to an atomic force, the conventional technique is not suitable for bonding of semiconductors or particularly oxides other than metals. Therefore, the present invention is the only low-temperature bonding method that is effective to semiconductors (Si, etc., not metal), and particularly, SiO₂, glass and ceramic which include oxides. In the case of bonding of Si objects, whereas a high vacuum state having 10⁻⁸ Torr is required in the conventional art, this technique can be preferably easily handled at a vacuum degree of about 10⁻² Torr.

The present invention also provides the bonding method according to any of claims 1 to 17, wherein the object to be bonded is a wafer or a chip cut off from a wafer (claim 18).

The present invention also provides the surface activating unit according to any of claims 20 to 36, wherein the object to be bonded is a wafer or a chip cut off from a wafer (claim 37).

This technique is particularly suitable since SiO₂ is used as an insulator in semiconductors. It is also effective for bonding of a semiconductor and a package since glass or ceramic, which are insulator, is frequently used. As a form, attachment by handling on a wafer during a semiconductor production process is most effective, and is also suitable for a chip state after dicing. The technique enables low-temperature bonding, and therefore, is suitable for semiconductor devices susceptible to heat since ions are stripped off by heating at high temperature after ion implantation.

The present invention also provides a device, such as a semiconductor device, an MEMS device or the like, which is produced using the bonding method according to any of claims 1 to 18 (claim 19).

This technique enables low-temperature bonding, and therefore, is suitable for semiconductor devices susceptible to heat since ions are stripped off by heating at high temperature after ion implantation. In the case of MEMS devices, in which different materials are stacked, distortion conventionally occurs due to high-temperature heating during bonding. Therefore, in the case of an actuator, malfunction occurs. However, this technique enables low-temperature bonding, so that distortion due to heat is preferably suppressed. In the case of a pressure sensor or the like, conventionally, glass and Si are bonded together, so that distortion due to high-temperature heating during bonding affects the reliability of the device. Since this technique enables low-temperature bonding, it is preferably possible to produce an MEMS device having high reliability.

The present invention also provides a bonding apparatus comprising the surface activating unit according to any of claims 20 to 37, wherein the apparatus collectively performs from the plasma hydrophilic treatment to the bonding (claim 38).

After the hydrophilic treatment using a plasma, bonding can be performed in the atmospheric air. However, by performing bonding in a vacuum chamber, exposure to the atmospheric air can be avoided, thereby making it possible to avoid readhering substances. As a result, a number of pure OH groups can achieve hydrogen bond, thereby providing a more effective method.

### EFFECTS OF THE INVENTION

In a bonding method for bonding objects to be bonded together in a solid phase at 500° C. or less after subjecting bonding surfaces of the objects to be bonded to a hydrophilic treatment using a plasma, a chemical treatment step of subjecting both the objects to be bonded to a chemical treatment using a plasma having a weak ion strike force is performed after a physical treatment step of subjecting both the objects to be bonded to a physical treatment using an energy wave having a strong ion strike force, the energy wave being an atom beam, an ion beam or a plasma, thereby bonding both the objects to be bonded together. Therefore, it is possible to perform a hydrophilic treatment without an organic substance layer. Therefore, a sufficient bonding strength can be obtained only by annealing at low temperature for releasing H₂O after achieving hydrogen bond and without diffusion. Also, by treating both the objects to be bonded in the same vacuum chamber, all steps can be performed in a single chamber.

Also, by reducing the ion strike force in the second half of the plasma treatment, a chemical reaction is promoted, so that a surface activation treatment can be uniformly performed with respect to a bonding surface. As a result, firm bond can be achieved at low temperature.

### BRIEF DESCRIPTION OF THE DRAWINGS

FIG. 1 is a schematic diagram illustrating a configuration of an apparatus according to a first embodiment of the present invention.

FIGS. 2A to 2H are a process diagram illustrating a bonding procedure of the first embodiment.

FIG. 3 is an alignment configuration diagram in which a two-side recognizing means is used in the atmospheric air.

FIG. 4 is an alignment configuration diagram in which an IR recognizing means is used in a vacuum.

FIGS. 5A to 5C are a diagram for explaining the principle of bonding of SiO₂ or Si using a hydrophilic treatment.

FIG. 6A to 6C are a diagram illustrating the principle of bonding using a hydrophilic treatment with a conventional organic substance.

FIG. 7 is a schematic diagram illustrating a configuration of an apparatus according to a second embodiment of the present invention.

FIGS. 8A to 8M are a process diagram illustrating a bonding procedure of the second embodiment.

FIG. 9 is a diagram for comparing and explaining bonding strengths regarding a plasma treatment method of the first embodiment.

FIG. 10 is a waveform diagram of an RF plasma power supply according to a third embodiment of the present invention.

FIG. 11 is a waveform diagram of a pulsed-wave plasma power supply according to a fourth embodiment of the present invention.

FIG. 12 is a schematic diagram illustrating a configuration of an apparatus according to a seventh embodiment of the present invention.

FIG. 13A to 13I are a process diagram illustrating a bonding procedure according to an eighth embodiment of the present invention.

FIG. 14 is a diagram for comparing and explaining bonding strengths regarding a plasma treatment method of the second to eighth embodiments.

### DESCRIPTION OF REFERENCE NUMERALS

1 Z axis

2 piston type head

3 chamber wall

4 sliding packing

5 fixing packing

6 upper electrode

7 upper wafer

8 lower wafer

9 lower electrode

10 chamber support

11 inlet

12 outlet

13 intake valve

14 discharge valve

15 vacuum pump

16 gas switch valve

17 gas A

18 gas B

19 mark read transparent portion

20 alignment table

21 glass window

22 IR recognizing means

23 upper mark

24 lower mark

25 two-side recognizing means

26 prism

27 upper mark recognizing means

28 lower mark recognizing means

201 torque control lifting/lowering drive motor

202 Z-axis lifting/lowering mechanism

203 θ-axis rotation mechanism

204 pressure detecting means

205 bellows

206 XY alignment table

207 head

208 stage

209 lower wafer

210 upper wafer

211 vacuum chamber

212 head's recognizing means

213 stage's recognizing means

214 glass window

215 gas discharge pipe

216 gas discharge valve

217 vacuum pump

218 gas intake pipe

219 gas intake valve

220 intake gas switch valve

221 Ar

222 O₂

223 atmospheric air

227 upper alignment mark

228 lower alignment mark

229 slide moving means

500 surface wave plasma generating means

501 RF plasma power supply

502 ion trapping plate

503 wafer

504 radical

505 ion

506 vacuum chamber

507 reaction gas supply inlet

508 gas discharge outlet

509 object-to-be-bonded holding electrode

510 microwave power supply

511 surface wave plasma generating region

512 RF plasma generating region

### BEST MODE FOR CARRYING OUT THE INVENTION

Hereinafter, preferred embodiments of the present invention will be described with reference to the accompanying drawings.

### First Embodiment

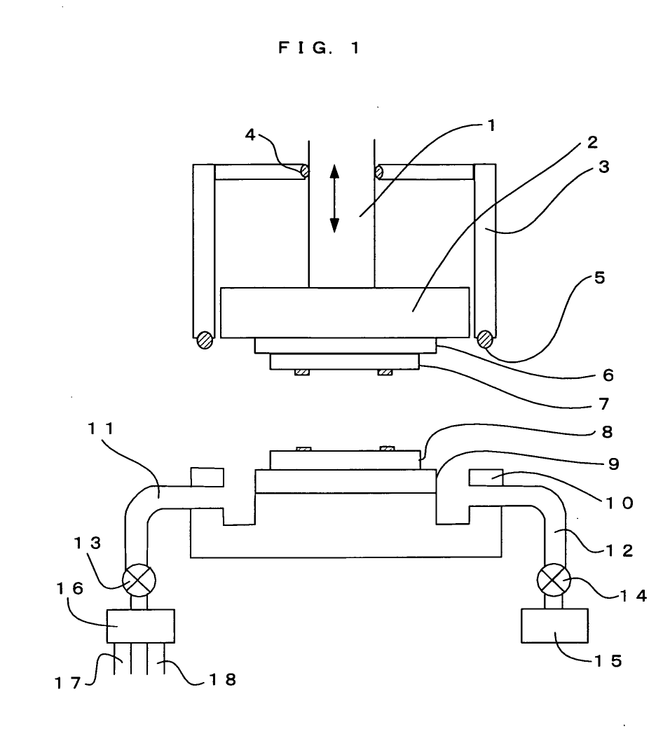

FIG. 1 illustrates an apparatus for wafer surface activation and bonding according to a first embodiment of the present invention. In this example, a physical treatment is a method of etching for removing impurities, which is a pretreatment for adhesion of OH groups. This embodiment provides an apparatus in which a chamber is closed while wafers (objects to be bonded) are held facing each other vertically, a surface activation treatment is performed using an Ar plasma and an oxygen plasma in vacuum, followed by bonding, and in some cases, a strength is increased by heating.

A configuration of the apparatus is divided into a head section which holds an upper wafer 7 and performs a lifting/lowering control and a pressing control using a Z axis 1, and a stage section which holds a lower wafer 8, and in some times, aligns a wafer. A pressure detecting means is incorporated into the Z axis 1, and performs a pressing force control by performing feedback with respect to a torque control of a Z-axis servo motor. Separately, a chamber wall 3 which can be lifted and lowered is lowered by an actuator, and is contacted via a fixing packing 5 to a chamber support 10. In this situation, the chamber is evacuated, a reaction gas is introduced, a plasma treatment is performed, and the head section is lowered to bond both the wafers together. In some cases, an upper electrode 6 and a lower electrode 9 may be provided with a heating heater which can perform heating during bonding.

Note that, in FIG. 1, 2 indicates a piston type head, 4 indicates a sliding packing, 11 indicates an inlet, 12 indicates an outlet, 13 indicates an intake valve, 14 indicates a discharge valve, 15 indicates a vacuum pump, 16 indicates a gas switch valve, 17 indicates a gas A, and 18 indicates a gas B.

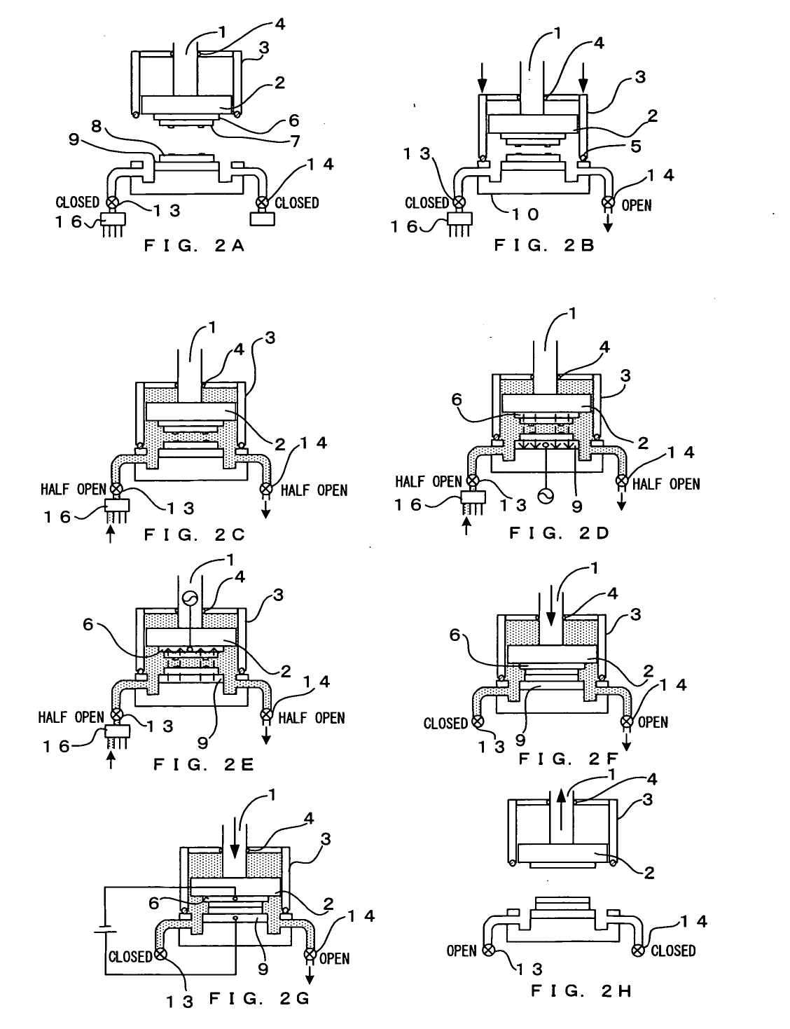

A treatment procedure will be described with reference to FIGS. 2A to 2H. As illustrated in FIGS. 2A, while the chamber wall 3 is in the lifted state, the upper wafer 7 is held by the upper electrode 6. The holding method may be a mechanical chuck method, or desirably an electrostatic chuck method.

Following this, the lower wafer 8 is held by the lower electrode 9. Next, as illustrated in FIG. 2B, the chamber wall 3 is lowered to contact the chamber support 10 via the fixing packing 5. The chamber wall 3 is sealed from the atmosphere by a sliding packing 4. Therefore, a discharge valve 14 is opened while an intake valve 13 is closed, and the chamber is evacuated using a vacuum pump 15, thereby making it possible to increase the degree of vacuum in the chamber.

Next, as illustrated in FIG. 2C, the chamber is filled with a reaction gas. By controlling a discharge amount at the discharge valve 14 and a gas intake amount at the intake valve 13 while the vacuum pump 15 is being operated, the chamber can be filled with the reaction gas while keeping a certain degree of vacuum. As illustrated in FIGS. 2D and 2E, in this embodiment, the chamber is initially filled with an Ar gas, and an alternating power supply plasma voltage is applied to the lower electrode 9, where the degree of vacuum is about 10⁻² Torr, thereby generating a plasma to clean a surface of the lower wafer 8 by Ar-etching. Following this, by applying a similar alternating power supply to the upper electrode 6, the upper wafer 7 is cleaned by Ar-etching. Next, as illustrated in FIG. 2B, the chamber is further evacuated than the plasma generating region to discharge Ar. In some cases, by performing evacuation while heating both the electrodes at about 100° C., Ar which adheres to a surface or is implanted into a part is discharged. Further, the steps of FIGS. 2C to 2E are performed, where an oxygen gas is supplied instead of Ar, thereby subjecting the surface to an oxygen plasma treatment.

A method of changing two gases (Ar and oxygen) in a single chamber, can select and supply Ar and oxygen gases using a gas switch valve 16. After Ar is initially selected to fill the chamber, the intake valve 13 is closed to evacuate the chamber to discharge Ar. Thereafter, the gas switch valve 16 is switched to an oxygen gas, and the intake valve 13 is opened to fill the chamber with the oxygen gas. The gas switch valve 16 can take the atmospheric air in. Therefore, when the chamber is opened, the chamber can be released to the atmospheric air.

Next, in some cases, a gas containing moisture is supplied to subject the surface to a hydrophilic treatment. Following this, as illustrated in FIG. 2F, the piston type head 2 is lowered by the Z axis 1 while the chamber wall 3 and the Z axis 1 contact each other via the sliding packing 4 in a vacuum, so that both the wafers are caused to contact each other in a vacuum, thereby bonding the wafers due to a hydrogen bonding force. The inside of the chamber is blocked from an external atmosphere by the sliding packing 4 between the chamber wall 3 and the Z axis 1, whereby the piston type head section can be lowered while being held in a vacuum. In some cases, the wafers are simultaneously heated to 200° C. to 400° C. by the heaters included in both the electrodes, thereby increasing a strength.

Thereafter, as illustrated in FIG. 2H, the atmospheric air is supplied into the chamber so that the pressure of the chamber is put back to the atmospheric pressure, the head section is lifted, and the bonded wafers 7 and 8 are removed out. In some cases, when bonding the wafers, the wafers may be bonded together after the positions of the wafers are aligned.

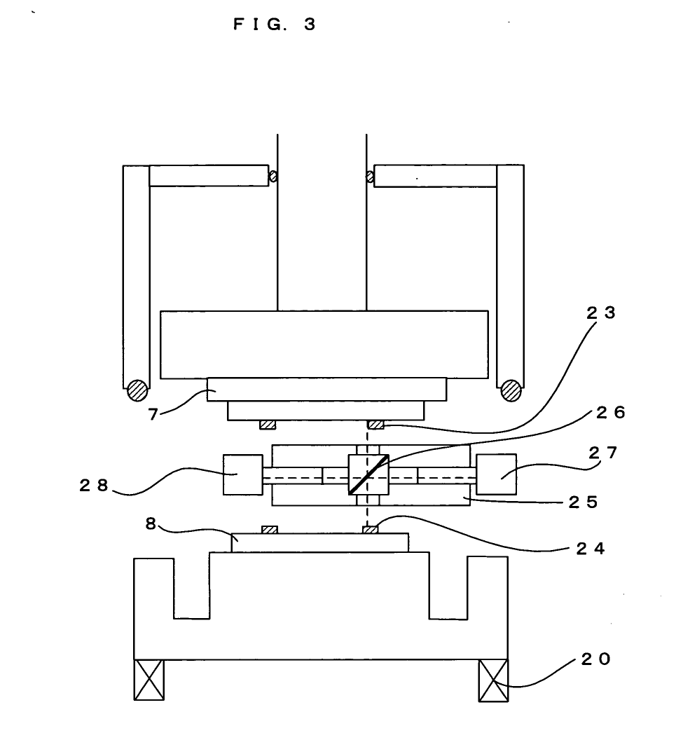

FIG. 3 illustrates a method of performing alignment before evacuation. Upper alignment marks 23 are attached to two portions of the upper wafer 7, and lower alignment marks 24 are attached to two similar portions of the lower wafer 8. A two-side recognizing means 25 is inserted between both the wafers, and the upper and lower mark positions are read using the recognizing means. The two-side recognizing means 25 splits upper and lower mark images using a prism 26, so that the upper and lower mark images are separately read by an upper mark recognizing means 27 and a lower mark recognizing means 28. Note that the two-side recognizing means 25 is moved using a table having the X and Y axes and, in some cases, the Z axis, thereby making it possible to read a mark at any arbitrary position. Thereafter, the position of the lower wafer 8 is corrected and shifted to the position of the upper wafer 7 using an alignment table 20. After shifting, the two-side recognizing means 25 can be inserted again to repeat correction, thereby improving accuracy.

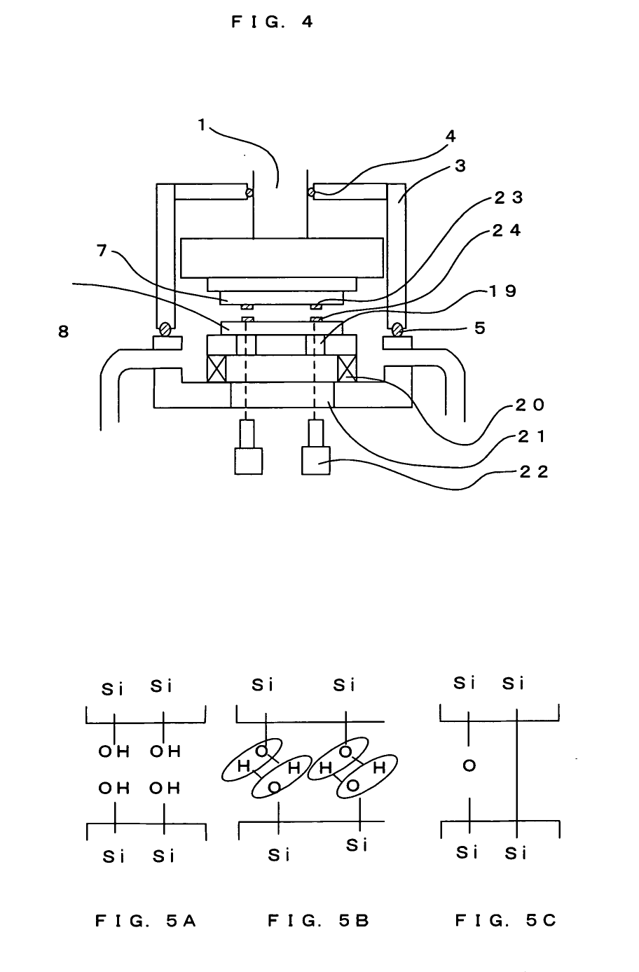

FIG. 4 illustrates a method capable of performing alignment even before bonding is performed after evacuation. Upper alignment marks 23 are attached to two portions of the upper wafer 7, and lower alignment marks 24 are attached to two portions of the lower wafer 8. The upper and lower marks have shapes which can be recognized in the same visual field even if they overlap each other. After a plasma treatment, both the wafers are placed close to each other, and the upper and lower alignment marks formed of a metal are simultaneously recognized and the positions thereof are read by an IR recognizing means 22, where a mark read transparent portion 19, a glass window 21, and the lower wafer are transparent with respect to the upper and lower alignment marks. When a correct depth of focus is not obtained, reading may be performed by moving the IR recognizing means 22 vertically. The IR recognizing means 22 may be moved using a table having the X and Y axes and, in some cases, the Z axis so as to read the marks at any arbitrary positions. Thereafter, the position of the lower wafer 8 may be corrected and shifted to the position of the upper wafer 7 using an alignment table 20. After shifting, the IR recognizing means 22 can be used again to repeat correction, thereby improving accuracy.

Next, a principle of bonding of SiO₂ or Si using a hydrophilic treatment is illustrated in FIGS. 5A to 5C. As illustrated in FIG. 5A, OH groups are caused to adhere to a Si surface by a hydrophilic treatment using an oxygen plasma. Next, as illustrated in FIG. 5B, both objects to be bonded are contacted and temporarily bonded together due to hydrogen bond. Following this, as illustrated in FIG. 5C, H₂O is released by heating, resulting in firm bond of Si—O—Si.

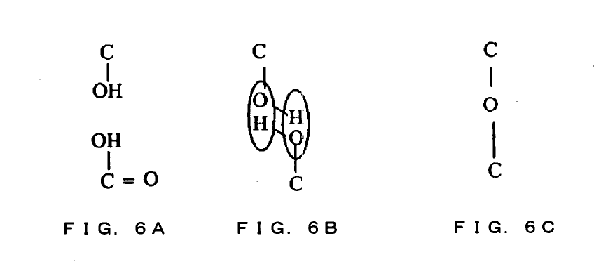

However, when the surface is contaminated with adhering substances (organic substances) as in the conventional art, the organic substance in the contaminated portion is reformed by an oxygen plasma as illustrated in FIG. 6A, so that OH groups are generated. Thereafter, as illustrated in FIGS. 6B and 6C, when this OH group is attached, due to hydrogen bond, with Si or an OH group of the organic substance on a surface of the other object to be bonded, since at least one of them is the organic substance, bonding strength is low even if moisture is directly released, so that firm bond cannot be obtained unless diffusion is performed at high temperature so that the organic substance layer is mixed and taken into crystal.

As a method of performing bonding after replacement with a gas containing H₂O or H and OH groups after the oxygen plasma treatment, a method of using a gas containing moisture is easy. Alternatively, an H₂O molecular beam, a hydrogen gas or the like can be used.

Etching is preferably performed using an Ar plasma in view of efficiency, however, etching may be performed using other gases, such as nitrogen, oxygen and the like in the present invention. When at least one of the objects to be bonded is made of Si, SiO₂, glass or ceramic, the material can be preferably efficiently etched using CF₄ as a plasma reaction gas.

As a plasma treatment method, the wafer held on the alternating electrode surface is preferably cleaned in view of efficiency, however, the electrode may be placed at a position other than the wafer and the wafer may be cleaned in view of uniformity or a reduction in damage.

In the configuration in which the IR recognizing means reads a mark, a passage of an IR light source in space or the like between the mark read transparent portion 19, the glass window 21, and the alignment table is not limited to space and glass, and may be formed of a material which transmits IR light. Instead of reflected light, transmitting light may be used, where a light source is provided on the opposite side of the IR (infrared) recognizing means.

An elastic material may be provided on a surface of at least one of the objects-to-be-bonded holding means, and when the objects to be bonded are bonded together, pressing may be performed via the elastic material with respect to both the objects to be bonded, thereby making it possible to increase the parallelism of the objects to be bonded. Also, it is possible to increase the flatness if the object to be bonded is thin.

The object-to-be-bonded holding means may be held on the stage and/or the head via a spherical bearing, and the objects to be bonded may be contacted and pressed by each other during or before bonding so that the tilt of at least one of the objects to be bonded can match the tilt of the other. With such a configuration, bonding can be achieved while increasing the parallelism.

When at least one of the objects to be bonded is made of Si, SiO₂, glass or ceramic and is treated with an oxygen plasma, bonding surfaces are subjected to a hydrophilic treatment, and bonding is performed by hydrogen bond, followed by heating at a low temperature of about 200° C. for one hour to release water molecules, thereby making it possible to convert the hydrogen bond into firm eutectic bond. Also, by applying a high voltage of about 500 V while both the objects to be bonded are contacted, water molecules can be efficiently removed.

### Second Embodiment

Hereinafter, a second preferred embodiment of the present invention will be described with reference to the drawings. In this embodiment, a method will be described which is performed in the step of adhesion of OH groups and in which, by changing an ion strike force, adhesion of oxygen is performed by a physical treatment, and adhesion of OH groups is increased by a chemical treatment, thereby performing adhesion of OH groups with high efficiency.

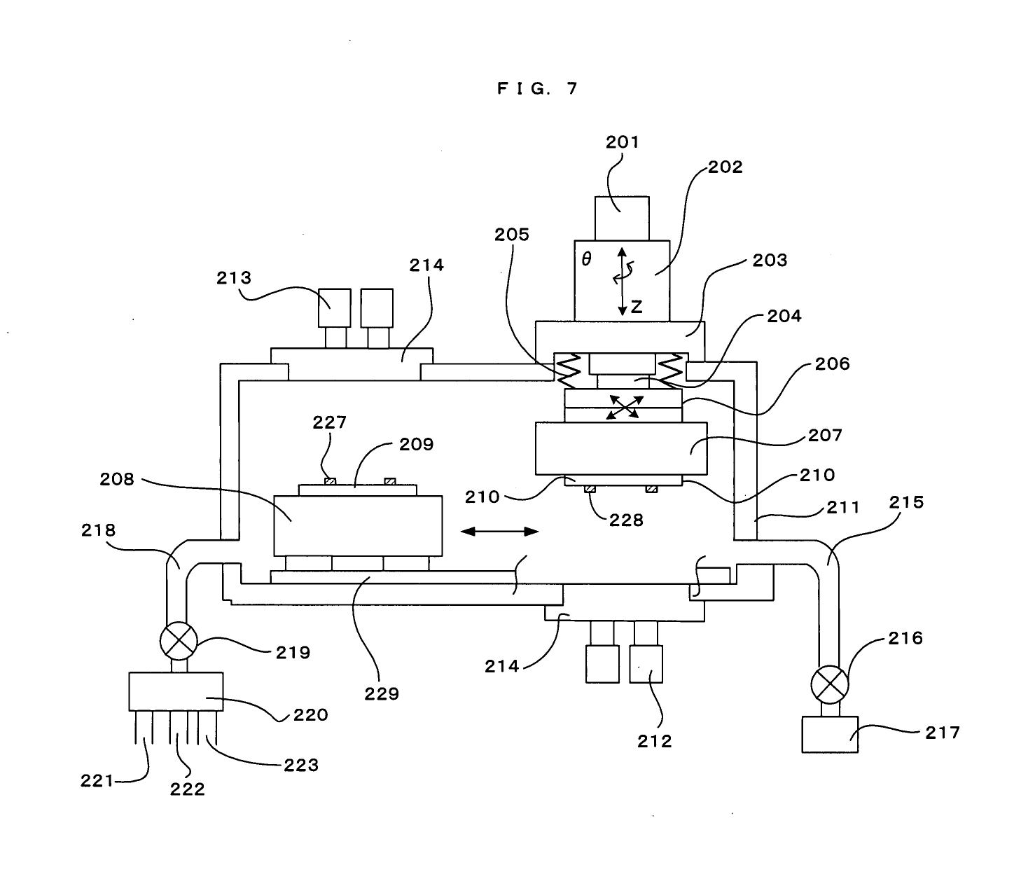

FIG. 7 illustrates a configuration of a bonding apparatus which performs a plasma treatment in a vacuum according to this embodiment. In this embodiment, the bonding apparatus is an exemplary apparatus which bonds an upper wafer (first object to be bonded) and a lower wafer (second object to be bonded) together.

Firstly, the apparatus configuration will be described. As illustrated in FIG. 7, a head 207 which holds an upper wafer and a stage 208 which holds a lower wafer 209 are provided in a vacuum chamber 211. The head comprises a Z-axis lifting/lowering mechanism 202 to which a torque control lifting/lowering drive motor 201 is linked, a θ-axis rotation mechanism 203 which rotates the Z-axis lifting/lowering mechanism 202, and an XY alignment table 206 which moves and aligns the head section in X and Y horizontal directions, which provide an aligning/moving means for the X, Y, and θ directions and a lifting/lowering means for the Z direction. A pressing force detected by a pressure detecting means 204 during bonding is fed back to the torque control lifting/lowering drive motor 201, thereby switching between a position control and a pressing force control. Also, the pressure detecting means 204 can be used to detect contact of objects to be bonded. The XY alignment table 206 can use a means which can be used in a vacuum. Since the Z- and θ-axis mechanisms are placed outside the vacuum chamber, the head section is blocked from the outside via a bellows 205 in a manner which allows the head section to move.

The stage 208 can be slid between a bonding position and a standby position by a slide moving means 229. A linear scale for high-accuracy guidance and position recognition is attached to the slide moving means, so that a stop position between the bonding position and the standby position can be maintained with high accuracy. The moving means is built in the vacuum chamber. However, if the moving means can be provided outside and linked to a linking rod via packing, a cylinder, a linear servo motor and the like can be provided outside. Alternatively, a ball screw can be provided in a vacuum, and a servo motor can be provided outside. Any moving means may be used. Although the object-to-be-bonded holding means of the head and the stage may be of a mechanical chucking type, an electrostatic chuck is preferably provided. The object-to-be-bonded holding means also comprises a heating heater, and also serves as a plasma electrode, i.e., has three functions: holding means; heating means; and plasma generating means.

Regarding a decompressing means, a vacuum pump 217 is coupled with a gas discharge pipe 215, and a gas discharge valve 216 is opened or closed so as to control a flow rate, so that the degree of vacuum can be controlled. Regarding an intake portion, an intake gas switch valve 220 is linked to a gas intake pipe 218, and a gas intake valve 219 is opened or closed so as to control a flow rate. Regarding intake gas, two plasma reaction gases can be linked. For example, Ar 221 and oxygen (O₂) 222 can be linked. Mixed gases having different mixture ratios can be linked. As the other one, the atmospheric air for atmospheric-pressure release or nitrogen containing water molecules is linked. The degree of vacuum including the atmospheric pressure and the reaction gas concentration can be controlled to be optimum values by a control of a flow rate, including opening or closing of the gas intake valve 219 and the gas discharge valve 216. In addition, a vacuum pressure sensor can be provided in the vacuum chamber to perform automatic feedback.

Alignment mark recognizing means comprising an optical system for alignment are provided outside the vacuum chamber above the stage standby position and below the head. Regarding the number of recognizing means, at least one needs to be provided for the stage and at least one needs to be provided for the head. Assuming that a small object, such as a chip, is recognized, if an alignment mark has a shape whose θ-direction component can be read or two marks are provided in one visual field, a single recognizing means is sufficient to read. However, when an object having a large radius, such as a wafer, is used as in this embodiment, two recognizing means are preferably provided at each end, thereby making it possible to read with high θ-direction accuracy.

The recognizing means may also be provided with a means which can move in a horizontal direction or a focusing direction, thereby reading an alignment mark placed at any arbitrary position. The recognizing means may comprise a camera having an optical lens for visible light or IR (infrared) light, for example. The vacuum chamber is provided with a window formed of a material which is transparent with respect to the optical system of the recognizing means, such as glass. An alignment mark on an object to be bonded in the vacuum chamber is recognized via the window. Alignment marks are provided on objects to be bonded (e.g., surfaces facing each other of an upper wafer or a lower wafer), thereby making it possible to recognize a position with high accuracy. Although the alignment mark is preferably in any specific shape, a portion of a circuit pattern provided on a wafer may be used as an alignment mark.

When a mark is not present, an outer shape, such as an orientation flat or the like, can be used. The alignment marks of both the upper and lower wafers are read at the stage standby position, the stage is shifted to a bonding position, and the head is moved so as to perform alignment in the X, Y, and θ directions. In order to reflect the result of reading at the standby position at the bonding position, accuracy is required so that a relative movement distance vector between the stage standby position and the bonding position repeatedly has the same result. Therefore, a guide which has high repetition accuracy is used, and a linear scale which reads position recognition at both the sides with high accuracy, are provided. When stop position accuracy is improved by feeding the linear scale back to the moving means, and the moving means is one which is like a simple cylinder or one which has a backlash, such as a bolt-nut mechanism, the linear scale is read at both the stop positions, an excess or a shortage is corrected when the head's aligning/moving means is moved, thereby making it possible to easily achieve high accuracy.

When fine alignment is performed with nano-level high accuracy, rough positioning is performed, and thereafter, while the upper wafer and the lower wafer are close to each other at a distance of about several micrometers, a visible light/IR recognizing means is used as the head's recognizing means, and a transparent hole or a transparent material is provided at an alignment mark position of the stage, so that the alignment marks on both the wafers are simultaneously recognized through the transparent stage from the bottom, whereby alignment can be achieved again in the X, Y, and θ directions. When the recognizing means has a moving means in a focusing direction, the upper and lower wafers can be separately recognized. However, it is preferable in terms of accuracy that the wafers be placed close to each other and be simultaneously recognized. Regarding the fine alignment, accuracy can be improved by repetition of alignment. The θ direction is affected by center displacement. Therefore, after the θ reaches within a predetermined range, alignment is performed only in the X and Y directions, thereby making it possible to improve the accuracy to a nano-level. Regarding the image recognizing means, recognition accuracy higher than or equal to the resolution of infrared can be obtained by using a subpixel algorithm. When alignment is performed after the wafers are placed close to each other, a Z movement amount required during bonding is within a minimum limit of several micrometers or less, so that play or tilt with respect to the Z movement can be minimized, resulting in high accuracy, i.e., nano-level bonding accuracy.

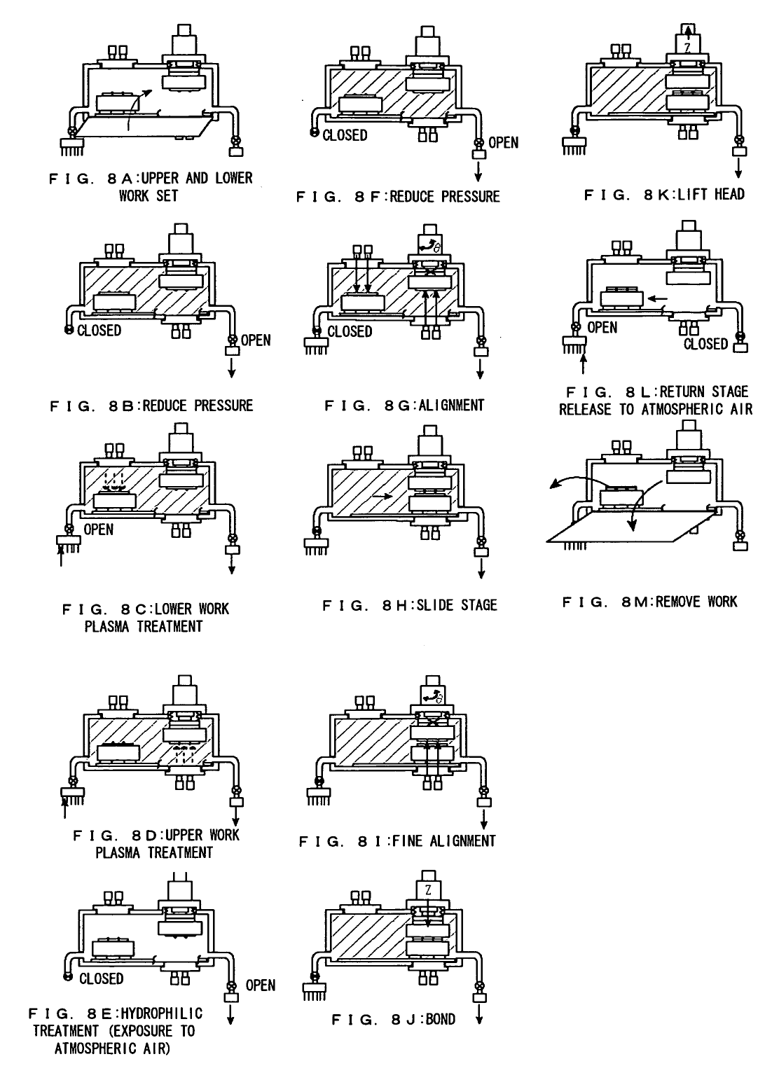

Next, an operation flow will be described with reference to FIGS. 8A to 8M. Firstly, as illustrated in FIG. 8A, while a front door of the vacuum chamber is open, the upper wafer and the lower wafer are held on the stage and the head. The wafers may be manually set or may be automatically loaded from a cassette. Next, as illustrated in FIG. 8B, the front door is closed, and the vacuum chamber is decompressed. In order to remove impurities, the pressure is preferably reduced to 10⁻³ Torr or less.

Next, as illustrated in FIGS. 8C and 8D, a plasma reaction gas (e.g., an oxygen gas) is supplied, and a plasma power supply is applied to the object-to-be-bonded holding electrode, where the degree of vacuum is constant at, for example, about 10⁻² Torr, so that a plasma is generated. Generated plasma ions go toward and strike surfaces of the wafer held by the electrode which is connected to a power supply, so that adhering substances, such as oxide film, an organic substance layer or the like, on the surface are etched. Since the striking ions replace or adhere to the surface layer, OH groups are attached and arranged on the surface. However, since the ion strike force is strong, a portion of the OH groups is removed again, resulting in irregularity. Adhering substances on the surface are unfortunately removed due to the strong ion strike force, thereby making it difficult to uniformly perform the chemical treatment on the surface. Therefore, in a second half of the plasma treatment, the plasma power supply is switched to the counter electrode to reduce the ion strike force and perform a plasma treatment. Therefore, in this case, since there are a number of ions or radicals, a chemical reaction is accelerated, so that the chemical treatment is uniformly performed on the bonding surface, thereby making it possible to arrange OH groups uniformly. At the same time, both the wafers can be cleaned. Alternatively, the wafers can be alternately cleaned by switching one matching box. The pressure is preferably reduced to 10⁻³ Torr or less so as to remove a reaction gas or etched matter after or during cleaning.

When adsorption of OH groups is not sufficient in the plasma treatment, OH groups can be easily generated by adsorption of moisture or hydrogen by exposure to a gas containing moisture or hydrogen under the atmospheric pressure or the atmospheric air as illustrated in FIG. 8E. Thereafter, when bonding is performed in the atmospheric air, the procedure goes to a step of FIG. 8G while exposure to the atmospheric air is continued. When bonding is performed in a vacuum, decompression is performed again as illustrated in FIG. 8F. When the adsorption step is not required, the procedure goes to the step of FIG. 8G while the decompressed state is maintained.

Following this, as illustrated in FIG. 8G, the alignment marks on the upper and lower wafers are read by the head's recognizing means and the stage's recognizing means at the stage standby position in a vacuum, thereby recognizing positions thereof. Thereafter, as illustrated in FIG. 8H, the stage is slid and shifted to a bonding position. In this case, a relative movement of the recognized standby position and the bonding position to which the stage is slid and shifted is performed using a linear scale.

When nano-level high accuracy is required, a step of FIG. 81 is added. Rough positioning is performed, and thereafter, while the upper wafer and the lower wafer are close to each other at a distance of about several micrometers, a visible light/IR (infrared) recognizing means is used as the head's recognizing means, and a transparent hole or a transparent material is provided at an alignment mark position of the stage, so that the alignment marks on both the wafers are simultaneously recognized through the transparent stage from the bottom, whereby alignment can be achieved again in the X, Y, and θ directions. In this case, accuracy can be improved by repetition of alignment. The θ direction is affected by center displacement. Therefore, after the θ reaches within a predetermined range, alignment is performed only in the X and Y directions, thereby making it possible to improve the accuracy to a nano-level.

Next, as illustrated in FIG. 8J, the head is lowered to contact both the wafers together, and the position control is switched to the pressing force control, in which pressing is in turn performed. The contact is detected by the pressure detecting means and a height position is recognized. In this situation, a value obtained by the pressure detecting means is fed back to the torque control lifting/lowering drive motor to perform a pressing force control so as to achieve a set pressure. Also, heat is applied during bonding as required. After contacting at room temperature, heating can be performed (temperature is increased) while keeping the accuracy.

Further, as illustrated in FIG. 8K, the head's holding means is released, and the head is lifted. Following this, as illustrated in FIG. 8L, the stage is moved back to the standby position, and the vacuum chamber is released to the atmospheric air. Next, as illustrated in FIG. 8M, the front door is opened, the bonded upper and lower wafers are removed. The wafers are unloaded into a cassette manually or preferably automatically.

An elastic material may be provided on a surface of at least one of the objects-to-be-bonded holding means, and when the objects to be bonded are bonded together, pressing may be performed via the elastic material with respect to both the objects to be bonded. Thereby, it is possible to increase the parallelism of the objects to be bonded. Also, it is possible to increase the flatness if the object to be bonded is thin.

The object-to-be-bonded holding means may be held on the stage and/or the head via a spherical bearing. Thereby, objects to be bonded may be contacted and pressed by each other during or before bonding so that the tilt of at least one of the objects to be bonded can match the tilt of the other. With such a configuration, bonding can be achieved after increasing the parallelism.

Since the objects to be bonded are surface-activated with the plasma treatment before bonding, as shown in FIG. 14, the heating temperature during bonding can be reduced to 200° C. or less as compared to the conventional art in which Si objects are bonded after being heated to 400° C. or more. Also, solid phase bonding can be achieved at 180° C. or less which is below 183° C. which is the melting point of conventional tin-lead solder. Also, bonding can be more preferably performed at 100° C. or less.

When at least one of the objects to be bonded is made of Si, SiO₂, glass or ceramic and is treated with an oxygen plasma, the bonding surfaces are subjected to a hydrophilic treatment, and bonding is performed by hydrogen bond, followed by heating at a low temperature of about 200° C. for one hour to release water molecules, thereby making it possible to convert the hydrogen bond into firm eutectic bond. Also, as illustrated in FIG. 26, by applying a high voltage of about 500 V while both the objects to be bonded are contacted, water molecules can be efficiently removed.

Since bonding can be achieved at low temperature by the above-described method, the method is preferable to semiconductors, which are weak to heat, and MEMS devices, which are susceptible to heat distortion. Also, since bonding can be achieved at low temperature, the method is preferable to semiconductor devices, in which ions are removed by heating at high temperature after ion implantation, i.e., which are susceptible to heat.

### Third Embodiment

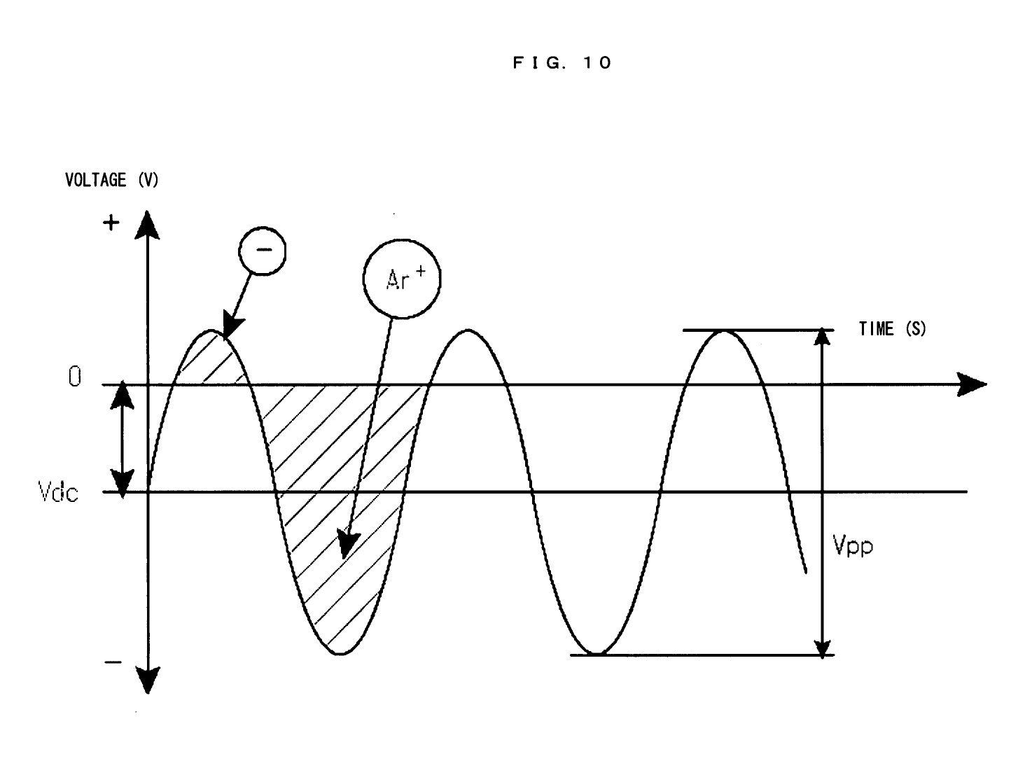

As the plasma treatment in which the ion strike force is changed, the plasma electrode is changed in the second embodiment. In a third embodiment, the low-pressure plasma is provided by an RF plasma power supply which can adjust Vdc, so that a Vdc value is changed in the second half of the plasma treatment to reduce the ion strike force. FIG. 10 is a waveform diagram of the RF plasma power supply.

On the plasma electrode side, electric field is generated, and a speed of striking ions varies depending on the Vdc value. For example, the larger the negative value of Vdc, the more the + oxygen ion is accelerated, so that an ion strike force is increased. As the negative value of Vdc approaches zero, the speed becomes slower, so that the ion strike force is reduced. In this case, there are a number of ions or radicals which are not accelerated, so that a chemical reaction is promoted. When a plasma treatment is performed by setting the Vdc value to be a large negative value, and thereafter, the Vdc value is caused to approach zero to perform an adsorption step, so that a plasma treatment using a reduced ion strike force is performed in the second half of the plasma treatment, impurities are removed and there are a number of ions or radicals which are not accelerated, due to the reduced ion strike force, thereby making it possible to promote a chemical reaction to uniformly perform surface activation with respect to a bonding surface. Therefore, the bonding strength can be increased at low temperature. The result of bonding similar to that of FIG. 14 was obtained.

### Fourth Embodiment

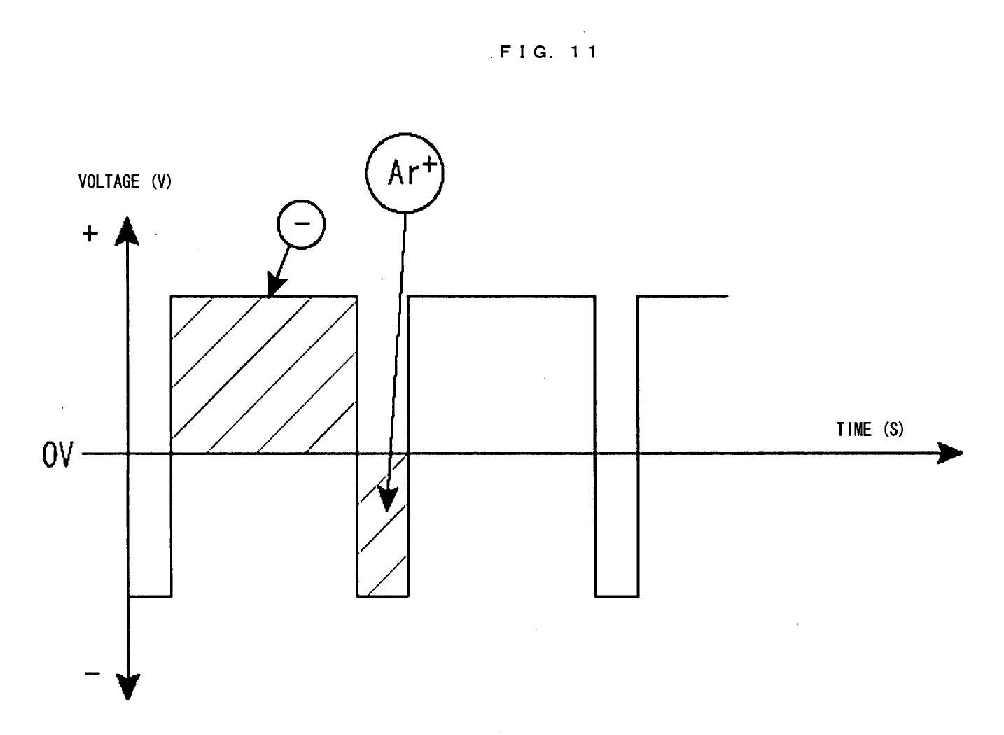

In a fourth embodiment, as the plasma treatment in which the ion strike force is changed, the low-pressure plasma is provided by a pulsed wave plasma power supply which can adjust a pulse width, so that the pulse width is changed in a second half of a plasma treatment to reduce the ion strike force. FIG. 11 is a waveform diagram of the pulsed wave plasma power supply.

On the plasma electrode side, electric field is generated, and by adjusting the pulse width, a time interval of − electric field in which + ions strike and a time interval of weak − electric field in which the strike is reduced can be adjusted. When the time of − electric field is increased, the strike of + ions is enhanced. When the time of − electric field is decreased, the strike of + ions is reduced. For example, the longer the time of − electric field, the more the + oxygen ions are accelerated, so that the ion strike force is increased. The shorter the time of − electric field, the slower the speed, so that the ion strike force is decreased. In this case, there are a number of ions or radicals which are not accelerated, resulting in promotion of a chemical reaction.

A plasma treatment is performed while the time of − electric field is increased by adjusting the pulse width, and thereafter, a plasma treatment is performed while the time of − electric field is decreased, so that, after a low-pressure plasma treatment in which the ion strike force is increased, a plasma treatment using a reduced ion strike force is performed, so that impurities are removed and there are a number of ions or radicals which are not accelerated, due to the reduced ion strike force, thereby making it possible to promote a chemical reaction to uniformly perform surface activation with respect to a bonding surface. Therefore, the bonding strength can be increased at low temperature. The result of bonding similar to that of FIG. 14 was obtained.

### Fifth Embodiment

In the second embodiment, the exemplary bonding due to hydrogen bond of OH groups using an oxygen plasma has been described. In a fifth embodiment, the reaction gas is composed of oxygen and nitrogen (mixture gas), and a chemical compound is generated so as to achieve bonding.

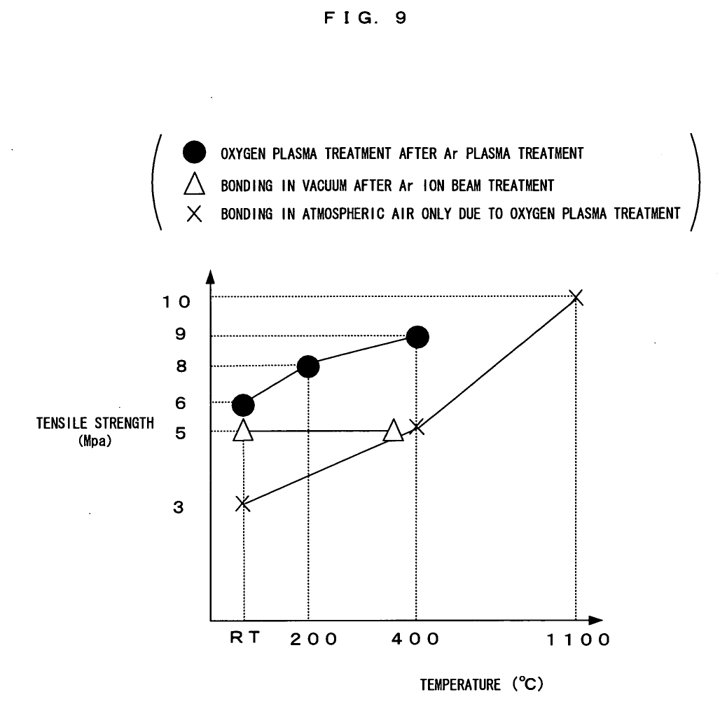

By using a gas containing nitrogen in addition to oxygen, a group containing O and N as well as an OH group are generated in the chemical treatment using the reduced ion strike force. Also, since OH groups adhere to some extent in the first half of the plasma treatment, the OH group is replaced with N in the chemical treatment using the reduced ion strike force. Thereby, a chemical compound of Si, O and N is generated at interface during bonding, so that firm bond can be achieved even at 100° C. or less, or room temperature. FIG. 9 illustrates comparison between when only an oxygen reaction gas was used and when a reaction gas containing oxygen and nitrogen was used.

When only oxygen is used, firm bond is not achieved unless heating is performed to about 200° C. When oxygen and nitrogen are mixed, firm bond can be achieved even at 100° C. or less, or room temperature.

### Sixth Embodiment

In the second embodiment, the exemplary bonding due to hydrogen bond caused by OH groups using an oxygen plasma has been described. In a sixth embodiment, at least one of the objects to be bonded is made of Si, glass or oxide, a different gas or a different gas mixture is used as the plasma reaction gas in the second half of the plasma treatment.

By using a different gas or a different gas mixture in the second half of the plasma treatment, the gas suitable for the chemical treatment can be preferably used. For example, an oxygen gas can be used in the first half and nitrogen gas can be used in the second half. Instead of simply using different gases, a gas mixture of oxygen and nitrogen may be used, i.e., a larger amount of oxygen is mixed in the first half and a larger amount of nitrogen is mixed in the second half.

Regarding the plasma reaction gas, a reaction gas containing oxygen is used, and is switched to a reaction gas containing nitrogen during the plasma treatment using the reduced ion strike force. In the chemical treatment using the reduced ion strike force, by using the gas containing nitrogen, a group containing O and N as well as an OH group are generated. Also, since OH groups adhere to some extent in the first half of the plasma treatment, the OH group is replaced with N in the chemical treatment using the reduced ion strike force. Thereby, a chemical compound of Si, O and N is generated at interface during bonding, so that firm bond can be achieved even at room temperature. With this method, a satisfactory result similar to that of FIG. 9 was obtained.

Also, in the second to sixth embodiments, one of the objects to be bonded can be treated with a gas, and the other can be treated with another gas, i.e., the objects to be bonded can be treated separately.

Also, in the second to sixth embodiments, in the above-described examples, the objects to be bonded are illustrated as wafers, and may be a chip and a substrate. The objects to be bonded are not limited to a wafer, a chip and a substrate and may be in any form.

Also, in the second to sixth embodiments, the means for holding an object to be bonded is desirably of the electrostatic chuck type, and may be of the mechanical chuck type. More preferably, objects to be bonded sucked and held by vacuum are tightly attached together in the atmospheric air before mechanical chucking, resulting in an improvement in tight attachment

Also, although the head has the aligning/moving means and the lifting/lowering axis and the stage has the sliding axis in the second to sixth embodiments, the aligning/moving means, the lifting/lowering axis, and the sliding axis may be assigned to the head and the stage in any combinations, or may overlap between the head and the stage. This does not depend on the arrangement direction. Specifically, the head and the stage do not have to be arranged vertically, and may be arranged laterally or obliquely.

Also, in the second to sixth embodiments, when the plasma treatment is performed while the stage is in the slid state, since the head and the stage have similar electrode shapes and peripheral shapes, electric field environments thereof are similar to each other. Therefore, separate matching boxes for automatically controlling the plasma power supply do not have to be used, and a single matching box can be used to change electrodes, so that the plasma treatment can be sequentially performed on the head and the stage. As a result, a compact size and a reduction in cost can be achieved.

### Seventh Embodiment

In a seventh embodiment, the plasma treatment means for changing the ion strike force is a means for changing two low-pressure plasma emitting means, i.e., a first plasma emitting means for applying a power supply to the object-to-be-bonded holding electrode to perform the plasma treatment, and a second plasma emitting means for trapping plasma ions generated in another room and emitting radicals in the second half of the plasma treatment. By changing the two means, the ion strike force is reduced, and a plasma treatment which promotes a chemical treatment is performed.

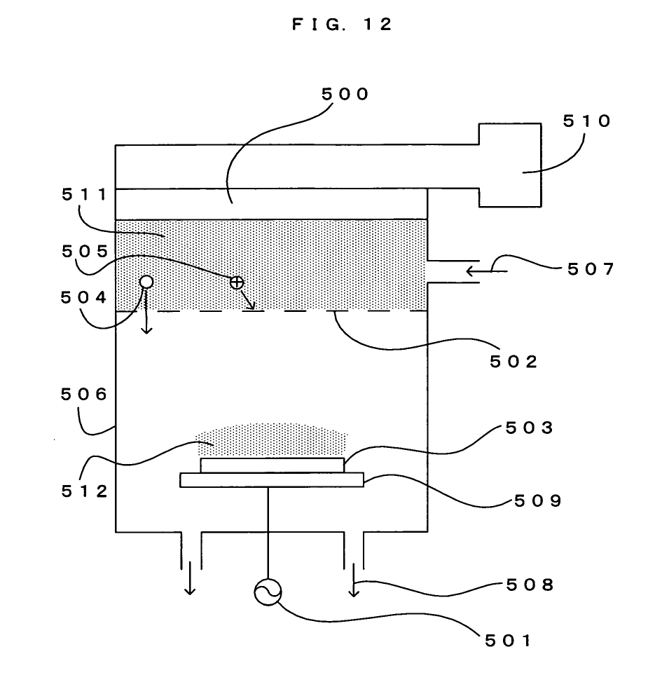

As illustrated in FIG. 12, while a wafer 503 (object to be bonded) is held by an object-to-be-bonded holding electrode (plasma power supply), an RF plasma power supply 501 is initially applied to perform a physical treatment in which ions strike the object to be bonded. Following this, the object to be bonded is irradiated with a larger number of radicals generated by an upper surface wave plasma through an ion trapping plate in a down-flow manner. Ions are captured by the ion trapping plate 502, so that a larger number of radicals can be emitted, thereby promoting a chemical treatment.

Note that, in FIG. 12, 500 indicates a surface wave plasma generating means, 504 indicates a radical, 505 indicates an ion, 506 indicates a vacuum chamber, 507 indicates a reaction gas supply inlet, 508 indicates a gas discharge outlet, 509 indicates an object-to-be-bonded holding electrode, 510 indicates a microwave power supply, 511 indicates a surface wave plasma generating region, and 512 indicates an RF plasma generating region.

### Eighth Embodiment

Hereinafter, an eighth embodiment in which an atmospheric-pressure plasma is used in the chemical treatment using the reduced ion strike force, will be described with reference to the drawings. In this embodiment, a chamber is closed while wafers (objects to be bonded) are held facing each other vertically, followed by treating the wafers with an oxygen plasma in a vacuum, and thereafter, the chamber wall is opened and an atmospheric-pressure plasma nozzle is inserted, following by an atmospheric-pressure plasma treatment, thereby bonding the wafers together. Note that, in some cases, heating may be performed to increase the strength.

The apparatus configuration of this embodiment is basically the same as that of FIG. 1 and overlapping parts will not be described. Note that this embodiment is different from the first embodiment in that, when the chamber wall is opened, the atmospheric-pressure plasma nozzle can be inserted to perform an atmospheric-pressure plasma treatment with respect to the upper and lower wafers. To increase efficiency, two nozzles may be vertically provided so that the upper and lower wafers can be simultaneously treated.

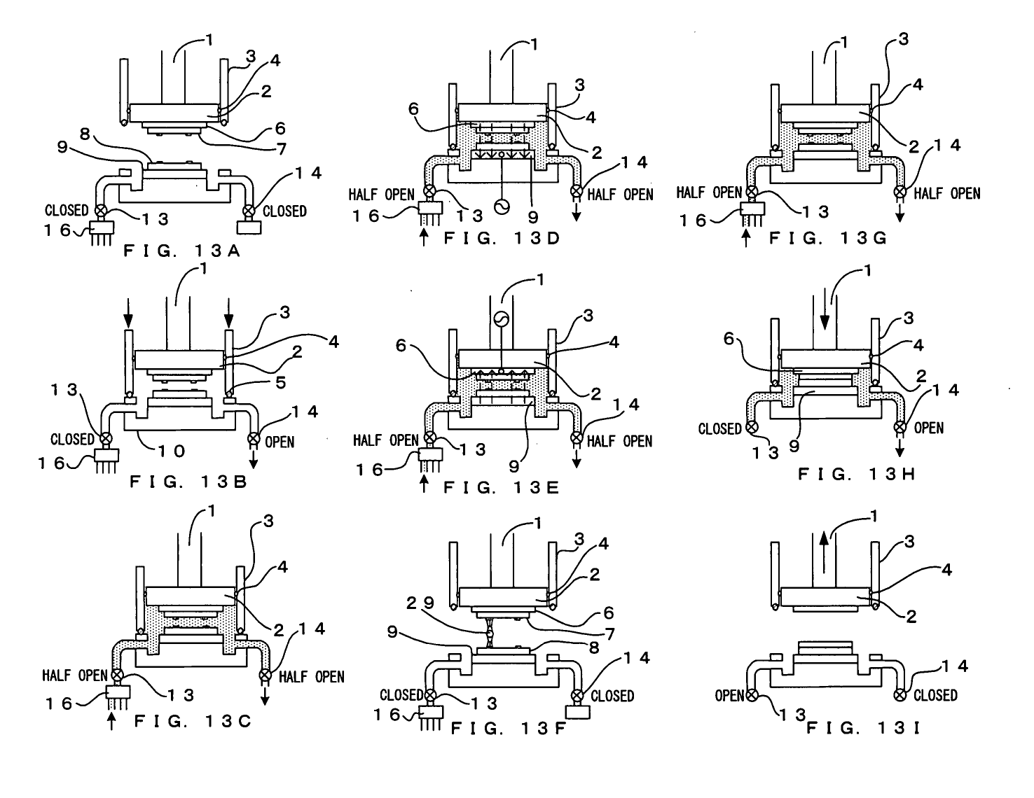

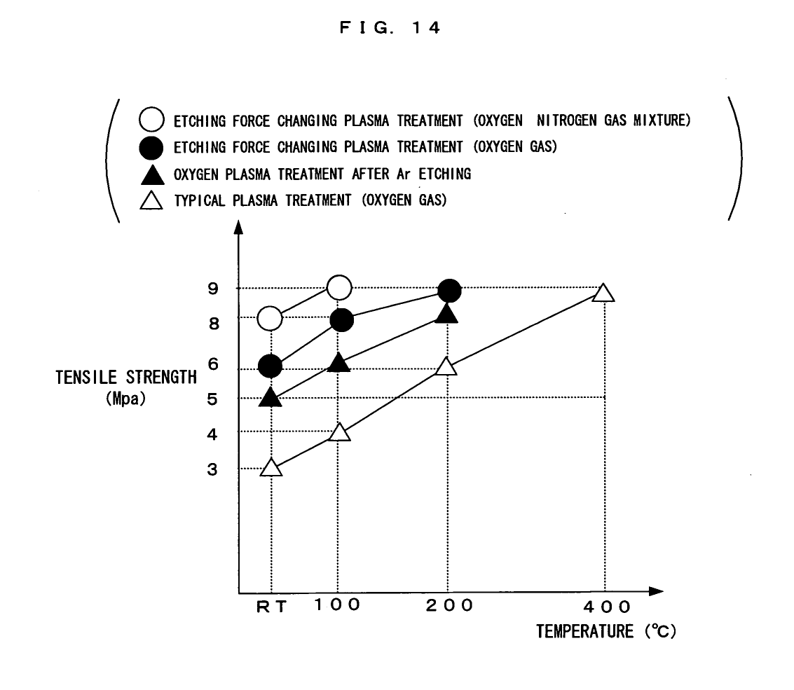

A procedure of this embodiment will be described with reference to FIGS. 13A to 13I. Firstly, as illustrated in FIG. 13A, while the chamber wall 3 is in the lifted state, the upper wafer 7 is held by the upper electrode 6. The holding method may be a mechanical chuck method, or desirably an electrostatic chuck method.

Following this, the lower wafer 8 is held by the lower electrode 9. Thereafter, as illustrated in FIG. 13B, the chamber wall 3 is lowered to contact the chamber support 10 via the fixing packing 5. The chamber wall 3 is sealed from the atmospheric air by the sliding packing 4. Therefore, by opening the discharge valve 14 while the intake valve 13 is closed, the chamber is evacuated using the vacuum pump 15, thereby making it possible to increase the degree of vacuum in the chamber.

Next, as illustrated in FIG. 13C, the chamber is filled with a reaction gas. By controlling a discharge amount at the discharge valve 14 and a gas intake amount at the intake valve 13 while the vacuum pump 15 is being operated, the chamber can be filled with the reaction gas while keeping a certain degree of vacuum. As illustrated in FIGS. 13D and 13E, in this embodiment, the chamber is initially filled with an oxygen gas, and an alternating power supply plasma voltage is applied to the lower electrode 9 where the degree of vacuum is about 10⁻² Torr, thereby generating a plasma to physically treat a surface of the lower wafer 8 using an oxygen plasma. Following this, by applying a similar alternating voltage to the upper electrode 6, the upper wafer 7 is physically treated using an oxygen plasma.

Next, as illustrated in FIG. 13F, the chamber wall is opened, and an atmospheric-pressure plasma nozzle 29 is inserted to perform a chemical treatment with respect to the upper and lower wafers using an atmospheric-pressure plasma. Thereafter, in some cases, a gas containing moisture is supplied to perform a hydrophilic treatment with respect to surfaces. Following this, as illustrated in FIG. 13G, the chamber wall is closed and decompression is performed, and as illustrated in FIG. 13H, the piston type head 2 is lowered by the Z axis 1 while the piston type head 2 contacts the chamber wall 3 via the sliding packing 4 in a vacuum, so that both the wafers contact each other in a vacuum, thereby bonding the wafers together due to a hydrogen bonding force.

The inside of the chamber is blocked from an external atmosphere by the sliding packing 4 between the chamber wall 3 and the piston type head 2, whereby the piston type head section can be lowered while being held in a vacuum. In some cases, the wafers are simultaneously heated to 100° C. to 200° C. by the heaters included in both the electrodes, thereby increasing a strength. Thereafter, as illustrated in FIG. 13I, the atmospheric air is supplied into the chamber so that the pressure of the chamber is put back to the atmospheric pressure, the head section is lifted, and the bonded wafers are removed out.

Note that, in some cases, bonding may be performed after both the wafers are aligned. Alignment before evacuation is performed as illustrated in FIG. 3.

As illustrated in FIG. 3, upper alignment marks 23 are attached to two portions of the upper wafer 7, and lower alignment marks 24 are attached to two similar portions of the lower wafer 8. A two-side recognizing means 25 is inserted between both the wafers, and the upper and lower mark positions are read using the recognizing means. The two-side recognizing means 25 splits upper and lower mark images using a prism 26, so that the upper and lower mark images are separately read by an upper mark recognizing means 27 and a lower mark recognizing means 28. The two-side recognizing means 25 is moved using a table having the X and Y axes and, in some cases, the Z axis, thereby making it possible to read a mark at any arbitrary position. Thereafter, the position of the lower wafer 8 is corrected and shifted to the position of the upper wafer 7 using an alignment table 20. After shifting, the two-side recognizing means 25 can be inserted again to repeat correction, thereby improving accuracy.

Alignment can be achieved even before bonding is performed after evacuation. As shown in FIG. 14, upper alignment marks 23 are attached to two portions of the upper wafer 7, and lower alignment marks 24 are attached to two portions of the lower wafer 8. The upper and lower marks have shapes which can be recognized in the same visual field even if they overlap each other. After a plasma treatment, both the wafers are placed close to each other, and the upper and lower alignment marks formed of a metal are simultaneously recognized and the positions thereof are read by an IR recognizing means 22, where a mark read transparent portion 19, a glass window 21, and the lower wafer are transparent with respect to the upper and lower alignment marks. When a correct depth of focus is not obtained, reading may be performed by moving the IR recognizing means 22 vertically. The IR recognizing means 22 may be moved using a table having the X and Y axes and, in some cases, the Z axis, thereby making it possible to read a mark at any arbitrary position. Thereafter, the position of the lower wafer 8 is corrected and shifted to the position of the upper wafer 7 using the alignment table 20. After shifting, the IR recognizing means 22 can be used again to repeat correction, thereby improving accuracy.

As a method of performing bonding after replacement with a gas containing H₂O or H and OH groups after the atmospheric-pressure plasma treatment, a method of using a gas containing moisture is easy. Alternatively, an H₂O molecular beam, a hydrogen gas or the like can be used.

As the low-pressure plasma treatment method, the wafer held on the alternating electrode surface is preferably treated in view of efficiency, however, the electrode may be placed at a position other than the wafer and the wafer may be treated in view of uniformity or a reduction in damage.

Since the objects to be bonded are surface-activated with the plasma treatment before bonding, as shown in FIG. 14, the heating temperature during bonding can be reduced to 200° C. or less as compared to a conventional technique in which Si objects are bonded after being heated to 400° C. or more. Also, solid phase bonding can be achieved at 180° C. or less which is below 183° C. which is the melting point of conventional tin-lead solder. Also, bonding can be more preferably performed at 100° C. or less or room temperature.

When at least one of the objects to be bonded is made of Si, SiO₂, glass or ceramic and is treated with an oxygen plasma, bonding surfaces are subjected to a hydrophilic treatment, and bonding is performed by hydrogen bond, followed by heating at a low temperature of about 200° C. for one hour to release water molecules, thereby making it possible to convert the hydrogen bond into firm eutectic bond. Also, as illustrated in FIG. 2G, by applying a high voltage of about 500 V while both the objects to be bonded are contacted, water molecules can be efficiently removed.

Since bonding can be achieved at low temperature by the above-described method, the method is preferable to semiconductors, which are weak to heat, and MEMS devices, which are susceptible to heat distortion. Also, since bonding can be achieved at low temperature, the method is preferable to semiconductor devices, in which ions are removed by heating at high temperature after ion implantation, i.e., which are susceptible to heat.

### INDUSTRIAL APPLICABILITY

Note that the present invention is not limited to the above-described embodiments, and various changes can be made without departing the spirit and scope of the present invention. The present invention can be applied to a variety of bonding of a plurality of objects to be bonded, such as a wafer and the like, and is particularly suitable for MEMS devices.

1. A bonding method for bonding objects to be bonded together in a solid phase at 500° C. or less after subjecting bonding surfaces of the objects to be bonded to a hydrophilic treatment using a plasma, wherein
a chemical treatment step of subjecting both said objects to be bonded to a chemical treatment using a plasma having a weak ion strike force is performed
after a physical treatment step of subjecting both said objects to be bonded to a physical treatment using an energy wave having a strong ion strike force, said energy wave being an atom beam, an ion beam or a plasma, thereby bonding both said objects to be bonded together.

2. The bonding method according to claim 1, wherein an energy wave of said physical treatment step is a plasma.

3. The bonding method according to claim 1, wherein a reaction gas of said chemical treatment step is oxygen or nitrogen.

4. The bonding method according to claim 1, wherein, after said physical treatment step, evacuation is performed before said chemical treatment step.

5. The bonding method according to claim 1, wherein, during or after said chemical treatment, a gas containing H₂O or H or OH groups is introduced and mixed before bonding.

6. The bonding method according to claim 1, wherein a reaction gas of said physical treatment step is different from a gas of said chemical treatment step, and is Ar or CF₄.

7. The bonding method according to claim 1, wherein said physical treatment step and said chemical treatment step are performed without exposure to the atmospheric air.

8. The bonding method according to claim 2, wherein by means of a plasma treatment means for changing the ion strike force,
said physical treatment is performed in a first half of a plasma treatment, the ion strike force is reduced in a second half of a plasma treatment so that said chemical treatment is promoted.

9. The bonding method according to claim 8, wherein said plasma treatment means for changing the ion strike force comprises a plasma electrode including an object-to-be-bonded holding electrode and a counter surface electrode which are provided at two positions and can be used for said plasma electrode alternatively,
a power supply is applied to said object-to-be-bonded holding electrode to generate a low-pressure plasma, thereby performing a plasma treatment for performing said physical treatment,
and thereafter, said power supply is applied to said counter surface electrode to reduce the ion strike force, thereby performing a plasma treatment for promoting said chemical treatment.

10. The bonding method according to claim 8, wherein said plasma treatment means for changing the ion strike force comprises an RF plasma power supply capable of adjusting a Vdc value,
said Vdc value of said RF plasma power supply is changed in said second half of the plasma treatment to reduce the ion strike force of a low-pressure plasma so that a plasma treatment for promoting said chemical treatment is performed.

11. The bonding method according to claim 8, wherein said plasma treatment means for changing the ion strike force comprises a pulsed-wave plasma power supply capable of adjusting a pulse width,
said pulse width of said a pulsed-wave plasma power supply is changed in said second half of the plasma treatment to reduce the ion strike force of a low-pressure plasma so that a plasma treatment for promoting said chemical treatment is performed.

12. The bonding method according to 8, wherein said plasma treatment means for changing the ion strike force comprises a first and a second low-pressure plasma emitting means each of which emits a low-pressure plasma having a different ion strike force; and means for switching between said first and said second low-pressure plasma emitting means,
a power supply is applied to an object-to-be-bonded holding electrode of said first low-pressure plasma emitting means in said first half of the plasma treatment to generate a low-pressure plasma, thereby performing a plasma treatment for performing said physical treatment,
in said second half of the plasma treatment, said first low-pressure plasma emitting means is switched to said second low-pressure plasma emitting means which traps plasma ions generated in another room and emits radicals, thereby reducing the ion strike force so that a plasma treatment for promoting said chemical treatment is performed.

13. The bonding method according to claim 8, wherein said plasma treatment means for changing the ion strike force is means for switching between a low-pressure plasma and an atmospheric-pressure plasma,
after subjecting said surfaces of the objects to be bonded to said physical treatment with an ion strike force enhanced by said low-pressure plasma,
the ion strike force is reduced with said atmospheric-pressure plasma so that a plasma treatment for promoting said chemical treatment is performed.

14. The bonding method according to claim 8, wherein a reaction gas is a mixed gas containing oxygen and nitrogen.

15. The bonding method according to claim 8, wherein a plasma reaction gas is switched from a reaction gas containing oxygen to a reaction gas containing nitrogen during a plasma treatment using a reduced ion strike force in said second half of the plasma treatment.

16. The bonding method according to claim 1, wherein, during said bonding, a voltage is applied between both said objects to be bonded so that said objects to be bonded are bonded together in a solid phase while being heated.

17. The bonding method according to claim 1, wherein at least one of said objects to be bonded is made of Si, SiO₂, glass or ceramic.

18. The bonding method according to claim 1, wherein said object to be bonded is a wafer or a chip cut off from a wafer.

19. A device, such as a semiconductor device, an MEMS device or the like, which is produced using the bonding method according to claim 1.

20. A surface activating unit for subjecting bonding surfaces of objects to be bonded to a hydrophilic treatment using a plasma for bonding said objects to be bonded together in a solid phase at 500° C. or less, said unit comprising:
an energy wave emitting means for performing a chemical treatment step of subjecting both said objects to be bonded to a chemical treatment using a plasma having a weak ion strike force
after a physical treatment step of subjecting both said objects to be bonded to a physical treatment using an energy wave having a strong ion strike force, said energy wave being an atom beam, an ion beam or a plasma.

21. The surface activating unit according to claim 20, wherein said energy wave emitting means is a plasma emitting means, said energy wave of said physical treatment step is a plasma generated by said plasma emitting means.

22. The surface activating unit according to claim 20, wherein a reaction gas of said chemical treatment step is oxygen or nitrogen.

23. The surface activating unit according to claim 20, wherein, after said physical treatment step, evacuation is performed before said chemical treatment step.

24. The surface activating unit according to claim 20, comprising a water gas generating means, wherein, during or after said chemical treatment, a gas containing H₂O or H and OH groups is introduced and mixed before bonding.

25. The surface activating unit according to claim 20, wherein a reaction gas of said physical treatment step is different from a gas of said chemical treatment step, and is Ar or CF₄.

26. The surface activating unit according to claim 20, wherein said physical treatment step and said chemical treatment step are performed without exposure to the atmospheric air.

27. The surface activating unit according to claim 21, comprising a plasma treatment means for changing the ion strike force, which functions as said plasma emitting means, wherein by means of said plasma treatment means,
said physical treatment is performed in a first half of a plasma treatment, the ion strike force is reduced in a second half of a plasma treatment so that said chemical treatment is promoted.

28. The surface activating unit according to claim 27, wherein said plasma treatment means for changing the ion strike force comprises a plasma electrode including an object-to-be-bonded holding electrode and a counter surface electrode which are provided at two positions and can be used for said plasma electrode alternatively,
a power supply is applied to said object-to-be-bonded holding electrode to generate a low-pressure plasma, thereby performing a plasma treatment for performing said physical treatment,
and thereafter, said power supply is applied to said counter surface electrode to reduce the ion strike force, thereby performing a plasma treatment for promoting said chemical treatment.

29. The surface activating unit according to claim 27, wherein said plasma treatment means for changing the ion strike force comprises an RF plasma power supply capable of adjusting a Vdc value,
said Vdc value of said RF plasma power supply is changed in said second half of the plasma treatment to reduce the ion strike force of a low-pressure plasma so that a plasma treatment for promoting said chemical treatment is performed.

30. The surface activating unit according to claim 27, wherein said plasma treatment means for changing the ion strike force comprises a pulsed-wave plasma power supply capable of adjusting a pulse width,
said pulse width of said a pulsed-wave plasma power supply is changed in said second half of the plasma treatment to reduce the ion strike force of a low-pressure plasma so that a plasma treatment for promoting said chemical treatment is performed.

31. The surface activating unit according to 27, wherein said plasma treatment means for changing the ion strike force comprises a first and a second low-pressure plasma emitting means each of which emits a low-pressure plasma having a different ion strike force; and means for switching between said first and said second low-pressure plasma emitting means,
a power supply is applied to an object-to-be-bonded holding electrode of said first low-pressure plasma emitting means in said first half of the plasma treatment to generate a low-pressure plasma, thereby performing a plasma treatment for performing said physical treatment,
in said second half of the plasma treatment, said first low-pressure plasma emitting means is switched to said second low-pressure plasma emitting means which traps plasma ions generated in another room and emits radicals, thereby reducing the ion strike force so that a plasma treatment for promoting said chemical treatment is performed.

32. The surface activating unit according to claim 27, wherein said plasma treatment means for changing the ion strike force is means for switching between a low-pressure plasma and an atmospheric-pressure plasma,
after subjecting said surfaces of the objects to be bonded to said physical treatment with an ion strike force enhanced by said low-pressure plasma,
the ion strike force is reduced with said atmospheric-pressure plasma so that a plasma treatment for promoting said chemical treatment is performed.

33. The surface activating unit according to claim 27, wherein a reaction gas is a mixed gas containing oxygen and nitrogen.

34. The surface activating unit according to claim 27, wherein a plasma reaction gas is switched from a reaction gas containing oxygen to a reaction gas containing nitrogen during a plasma treatment using a reduced ion strike force in said second half of the plasma treatment.

35. The surface activating unit according to claim 20, wherein, during the bonding, a voltage is applied between both said objects to be bonded so that said objects to be bonded are bonded together in a solid phase while being heated.

36. The surface activating unit according to claim 20, wherein at least one of said objects to be bonded is made of Si, SiO₂, glass or ceramic.

37. The surface activating unit according to claim 20, wherein said object to be bonded is a wafer or a chip cut off from a wafer.

38. A bonding apparatus comprising:
said surface activating unit according to claim 20; and means for bonding both said objects to be bonded together, wherein
said apparatus collectively performs from said hydrophilic treatment using said surface activating unit to said bonding using said means for bonding.
